(19) United States
(12) Patent Application Publication
(10) Pub. No.: US 2021/0248689 A1
(43) Pub. Date: Aug. 12, 2021

(54) MANAGEMENT OF A MEDIA ARCHIVE REPRESENTING PERSONAL MODULAR MEMORIES

(71) Applicant: MiLegacy, LLC, Los Gatos, CA (US)

(72) Inventors: Kenneth J. HUENING, Los Gatos, CA (US); N'Dalo SILVEIRA, Morgan Hill, CA (US)

(21) Appl. No.: 17/243,155

(22) Filed: Apr. 28, 2021

Related U.S. Application Data
(63) Continuation of application No. 15/988,617, filed on May 24, 2018.
(60) Provisional application No. 62/517,810, filed on Jun. 9, 2017.

(51) Int. Cl. G06Q 50/00; H04L 29/08; G06F 3/0481

(52) U.S. Cl. CPC G06Q 50/01; G06F 3/04817; H04L 67/22; H04L 67/306

(57) ABSTRACT

Management of a media archive representing personal memories. In an embodiment, a graphical user interface, comprising one or more inputs, is generated for a first user. Text, one or more media, and a selection of at least one topic, representing a life milestone, are received from the user via the one or more inputs. A modular content item is generated to comprise the text and one or more media. The modular content item is stored in association with the user and that at least one topic, such that the modular content item may be retrieved based on one and both of the user and the at least one topic. This modular content item may be provided in a graphical user interface of at least one other user.

### CROSS-REFERENCE TO RELATED APPLICATIONS

This application is a continuation of U.S. patent application Ser. No. 15/988,617, filed on May 24, 2018, which claims priority to U.S. Provisional Patent App. No. 62/517,810, filed on Jun. 9, 2017, which are both hereby incorporated herein by reference as if set forth in full.

### BACKGROUND

### Field of the Invention

The embodiments described herein are generally directed to managing content, and, more particularly, to the management of a media archive representing personal modular memories.

### Description of the Related Art

While there are numerous social media platforms available, what is needed is a platform that enables the creation, sharing, and passing on of milestone-based modular content items that represent users' personal memories.

### SUMMARY

Accordingly, systems, methods, and non-transitory computer-readable media are disclosed for managing a media archive representing personal memories.

In an embodiment, a method is disclosed that comprises using at least one hardware processor to: generate a graphical user interface for a first user, wherein the graphical user interface comprises one or more inputs; via the one or more inputs of the graphical user interface, receive text, one or more media, and a selection of at least one topic from the first user, wherein the at least one topic represents a life milestone; generate a modular content item comprising the text and one or more media; store the modular content item in association with the first user and the at least one topic, such that the modular content item may be retrieved based on one and both of the first user and the at least one topic; and provide the modular content item in a graphical user interface of at least one second user that is different than the first user.

In another or further embodiment, a method is disclosed that comprises using at least one hardware processor to: at a server, receive a definition of an event from a client application of a first user over at least one network, wherein the definition of the event comprises a time and location; at the server, generate and store an event content item, comprising the time and location; by the server, provide an invite to the event to each of a plurality of client applications of second users; at the server, receive an acceptance of the invitation from at least a subset of the plurality of client applications of the second users; and, during the time of the event, by each of the at least a subset of client applications of the second users executing on client devices located at the location of the event, automatically upload media captured by the client devices to the server over the at least one network.

In another or further embodiment, a method is disclosed that comprises using at least one hardware processor to: for one or more other users, from a user, receive a request to establish a contact with the other user, wherein the request specifies a familial relationship, provide the request to establish a contact to the other user, and, in response to receiving an acceptance of the request to establish a contact from the other user, establish the familial relationship between the user and other user in a representation of a social network that includes the user; infer an unestablished familial relationship between the user and another user based on established familial relationships represented in the social network; and generate a visual representation of a family tree of the user based on both the inferred and established familial relationships, wherein the visual representation of the family tree distinguishes any inferred familial relationships from any established familial relationships.

In another embodiment, a system is disclosed that comprises: at least one hardware processor; and one or more software modules that, when executed by the at least one hardware processor, perform any of the disclosed methods.

In another embodiment, a non-transitory computer-readable medium having instructions stored therein is disclosed. The instructions, when executed by a processor, cause the processor to perform any of the disclosed methods.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein, may be implemented, according to an embodiment;

FIG. 2 illustrates an example processing system, by which one or more of the processed described herein, may be executed, according to an embodiment;

FIG. 3 illustrates various components of an application, according to an embodiment;

FIGS. 4A-4AE illustrate various screens in a graphical user interface of the application, according to an embodiment;

FIG. 5 illustrates various processes that may be implemented by the application, according to an embodiment;

FIG. 6 illustrates an account-related process, according to an embodiment;

FIG. 7 illustrates a process for uploading media and/or providing feedback, according to an embodiment;

FIG. 8 illustrates a process for sending a gift, according to an embodiment;

FIG. 9 illustrates a process for managing contacts, according to an embodiment;

FIG. 10 illustrates a process for managing a time capsule, according to an embodiment;

FIG. 11 illustrates a process for generating highlights, according to an embodiment;

FIGS. 12A-12B illustrate a process for collecting media for an event, according to an embodiment;

FIG. 13 illustrates a process for sending advice, according to an embodiment;

FIG. 14 illustrates a process for managing a proxy account, according to an embodiment; and

FIG. 15 illustrates a process for automated approval of contacts, according to an embodiment.

### DETAILED DESCRIPTION

In an embodiment, systems, methods, and non-transitory computer-readable media are disclosed for managing a media archive representing personal modular memories. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

1. System Overview

1.1. Infrastructure

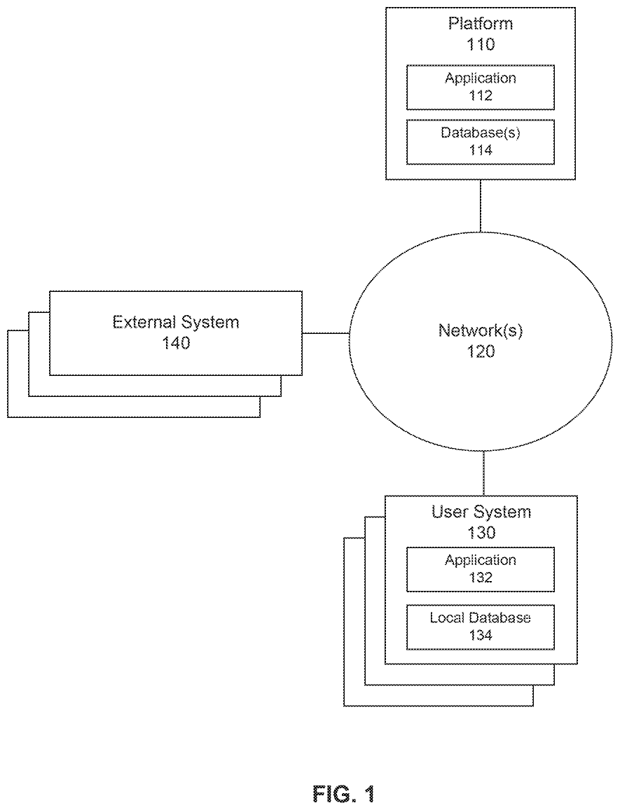

FIG. 1 illustrates an example system for managing a media archive representing personal modular memories, according to an embodiment. The infrastructure may comprise a platform 110 (e.g., one or more servers) which hosts and/or executes one or more of the various functions, processes, methods, and/or software modules described herein. Platform 110 may comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., web services, other platforms, etc.) via one or more networks 120. Network(s) 120 may comprise the Internet, and platform 110 may communicate with user system(s) 130 through the Internet using standard transmission protocols, such as HyperText Transfer Protocol (HTTP), Secure HTTP (HTTPS), File Transfer Protocol (FTP), FTP Secure (FTPS), SSH FTP (SFTP), and/or the like, as well as proprietary protocols. In an embodiment, platform 110 may not comprise dedicated servers, but may instead comprise cloud instances, which utilize shared resources of one or more servers. It should also be understood that platform 110 may comprise, but is not required to comprise, collocated servers or cloud instances. Furthermore, while platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet.

User system(s) 130 may comprise any type or types of computing devices capable of wired and/or wireless communication, including without limitation, desktop computers, laptop computers, tablet computers, smart phones or other mobile devices, servers, game consoles, televisions, set-top boxes, electronic kiosks, point-of-sale terminals, and/or the like. In addition, while only a few user systems 130 and external systems 140, one server application 112, and one set of database(s) 114 are illustrated, it should be understood that the infrastructure may comprise any number of user systems, server applications, and databases.

Platform 110 may comprise web servers which host one or more websites and/or web services. In embodiments in which a website is provided, the website may comprise one or more screens of a graphical user interface, including, for example, webpages generated in HyperText Markup Language (HTML) or other language. Platform 110 transmits or serves these screens in response to requests from user system(s) 130. In some embodiments, these screens may be served in the form of a wizard, in which case two or more screens may be served in a sequential manner, and one or more of the sequential screens may depend on an interaction of the user or user system with one or more preceding screens. The requests to platform 110 and the responses from platform 110, including the screens, may both be communicated through network(s) 120, which may include the Internet, using standard communication protocols (e.g., HTTP, HTTPS). These screens (e.g., web pages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and/or the like, including elements comprising or derived from data stored in one or more databases (e.g., database(s) 114, 134) that are locally and/or remotely accessible to platform 110. Elements within the screens may be selected or otherwise interacted with using standard input operations (e.g., mouse pointer, keyboard, touch operations via a touch panel display, such as a press, long-press, drag, drag-and-drop, flick, pinch-in, pinch-out, etc., line-of-sight detection, etc.). Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Sybase™, Access™, and the like, including cloud-based database instances and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., application 112), executed by platform 110.

In embodiments in which a web service is provided, platform 110 may receive requests from external system(s) 140, and provide responses in eXtensible Markup Language (XML) and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own graphical user interface, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application is a browser application, which simply requests, receives, and renders webpages at user system(s) 130, while server application 112 on platform 110 is responsible for generating the webpages and managing database functions. Alternatively, client application 132 may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case application 112 performs all processing) or user system(s) 130 (e.g., in which case application 132 performs all processing) or be distributed between platform 110 and user system(s) 130 (e.g., in which case server application 112 and client application 132 both perform processing), can comprise one or more executable software modules that implement one or more of the processes, methods, or functions of the application(s) described herein.

In an embodiment, the application may be available in one or both of a non-mobile version (e.g., designed for use with a large display, such as a desktop monitor or television) and a mobile version (e.g., designed for use with a small display, such as the display of a smart phone or tablet). In addition, in embodiments which utilize a client application 132 (e.g., to provide a graphical user interface based on data served by server application 112), client application 132 may be downloaded, for example, from a remote server, for example, representing an “app store.”

1.2. Example Processing Device

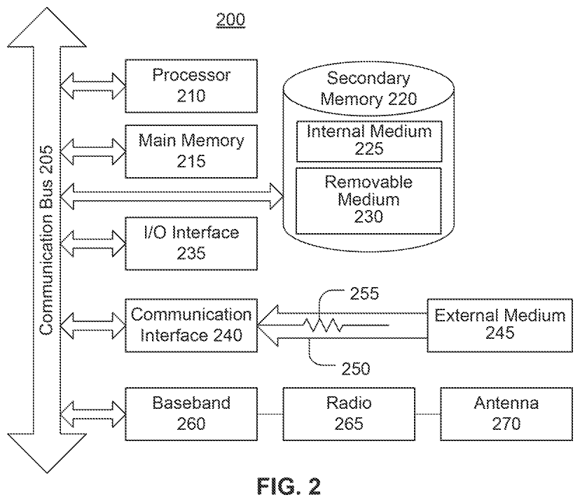

FIG. 2 is a block diagram illustrating an example wired or wireless system 200 that may be used in connection with various embodiments described herein. For example system 200 may be used as or in conjunction with one or more of the mechanisms, processes, methods, or functions (e.g., to store and/or execute the application or one or more software modules of the application) described herein, and may represent components of platform 110, user system(s) 130, external system(s) 140, and/or other processing devices described herein. System 200 can be a server or any conventional personal computer, or any other processor-enabled device that is capable of wired or wireless data communication. Other computer systems and/or architectures may be also used, as will be clear to those skilled in the art.

System 200 preferably includes one or more processors, such as processor 210. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 210. Examples of processors which may be used with system 200 include, without limitation, the Pentium® processor, Core i7® processor, and Xeon® processor, all of which are available from Intel Corporation of Santa Clara, Calif.

Processor 210 is preferably connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPM), IEEE 696/S-100, and the like.

System 200 preferably includes a main memory 215 and may also include a secondary memory 220. Main memory 215 provides storage of instructions and data for programs executing on processor 210, such as one or more of the functions and/or modules discussed above. It should be understood that programs stored in the memory and executed by processor 210 may be written and/or compiled according to any suitable language, including without limitation C/C++, Java, JavaScript, Perl, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 220 may optionally include an internal memory 225 and/or a removable medium 230. Removable medium 230 is read from and/or written to in any well-known manner. Removable storage medium 230 may be, for example, a magnetic tape drive, a compact disc (CD) drive, a digital versatile disc (DVD) drive, other optical drive, a flash memory drive, etc.

Removable storage medium 230 is a non-transitory computer-readable medium having stored thereon computer-executable code (e.g., disclosed software modules) and/or data. The computer software or data stored on removable storage medium 230 is read into system 200 for execution by processor 210.

In alternative embodiments, secondary memory 220 may include other similar means for allowing computer programs or other data or instructions to be loaded into system 200. Such means may include, for example, an external storage medium 245 and a communication interface 240, which allows software and data to be transferred from external storage medium 245 to system 200. Examples of external storage medium 245 may include an external hard disk drive, an external optical drive, an external magneto-optical drive, etc. Other examples of secondary memory 220 may include semiconductor-based memory such as programmable read-only memory (PROM), erasable programmable read-only memory (EPROM), electrically erasable read-only memory (EEPROM), or flash memory (block-oriented memory similar to EEPROM).

As mentioned above, system 200 may include a communication interface 240. Communication interface 240 allows software and data to be transferred between system 200 and external devices (e.g. printers), networks, or other information sources. For example, computer software or executable code may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 200 with a network or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 240 are generally in the form of electrical communication signals 255. These signals 255 may be provided to communication interface 240 via a communication channel 250. In an embodiment, communication channel 250 may be a wired or wireless network, or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules) is stored in main memory 215 and/or the secondary memory 220. Computer programs can also be received via communication interface 240 and stored in main memory 215 and/or secondary memory 220. Such computer programs, when executed, enable system 200 to perform the various processes and functions of the application described herein.

In this description, the term “computer-readable medium” is used to refer to any non-transitory computer-readable storage media used to provide computer-executable code (e.g., software and computer programs) to system 200. Examples of such media include main memory 215, secondary memory 220 (including internal memory 225, removable medium 230, and external storage medium 245), and any peripheral device communicatively coupled with communication interface 240 (including a network information server or other network device). These non-transitory computer-readable mediums are means for providing executable code, programming instructions, and software to system 200.

In an embodiment that is implemented using software, the software may be stored on a computer-readable medium and loaded into system 200 by way of removable medium 230, I/O interface 235, or communication interface 240. In such an embodiment, the software is loaded into system 200 in the form of electrical communication signals 255. The software, when executed by processor 210, preferably causes processor 210 to perform the processes and functions described elsewhere herein.

In an embodiment, I/O interface 235 provides an interface between one or more components of system 200 and one or more input and/or output devices. Example input devices include, without limitation, keyboards, touch screens or other touch-sensitive devices, biometric sensing devices, computer mice, trackballs, pen-based pointing devices, and/or the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 200 may also include optional wireless communication components that facilitate wireless communication over a voice network and/or a data network. The wireless communication components comprise an antenna system 270, a radio system 265, and a baseband system 260. In system 200, radio frequency (RF) signals are transmitted and received over the air by antenna system 270 under the management of radio system 265.

In one embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then the signal is amplified and sent to a speaker. Baseband system 260 also receives analog audio signals from a microphone. These analog audio signals are converted to digital signals and encoded by baseband system 260. Baseband system 260 also codes the digital signals for transmission and generates a baseband transmit audio signal that is routed to the modulator portion of radio system 265. The modulator mixes the baseband transmit audio signal with an RF carrier signal generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 is also communicatively coupled with processor 210, which may be a central processing unit (CPU). Processor 210 has access to data storage areas 215 and 220. Processor 210 is preferably configured to execute instructions (i.e., computer programs, such as the disclosed application, or software modules) that can be stored in main memory 215 or secondary memory 220. Computer programs can also be received from baseband processor 260 and stored in main memory 210 or in secondary memory 220, or executed upon receipt. Such computer programs, when executed, enable system 200 to perform the various functions of the disclosed embodiments. For example, data storage areas 215 or 220 may include various software modules.

1.3. Application Overview

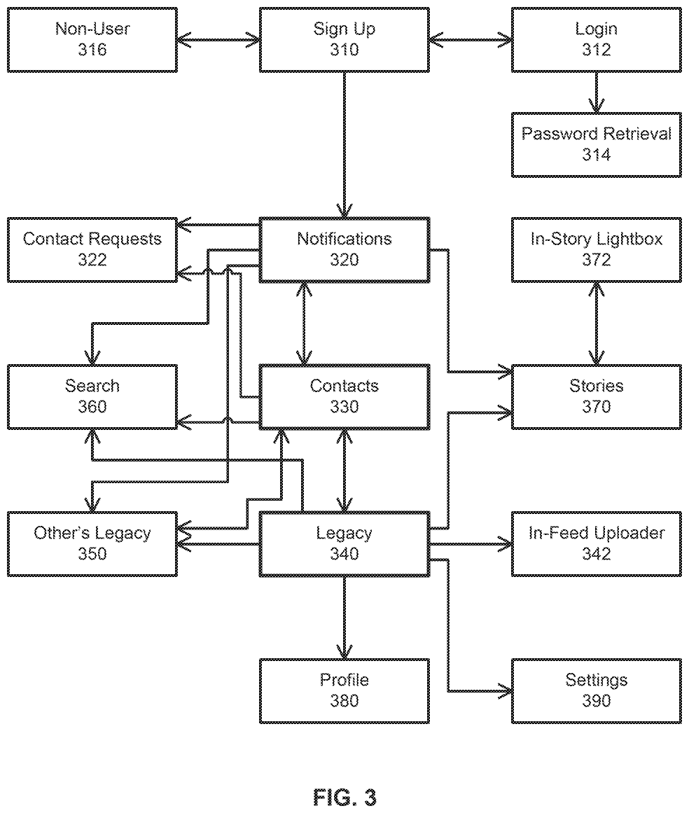

FIG. 3 illustrates various software components of the disclosed application, according to an embodiment. These components may comprise a plurality of executable software modules, including, without limitation, a sign-up module 310, a login module 312, a password-retrieval module 314, a non-user module 316, a notifications module 320, a contact-requests module 322, a contacts module 330, a legacy module 340, an in-feed-uploader module 342, an other's-legacy module 350, a search module 360, a stories module 370, an in-story-lightbox module 372, a profile module 380, and a settings module 390.

While the graphical user interface, described herein, will be primarily illustrated as comprising a plurality of screens of a mobile version of the application, non-mobile versions of the various screens of the graphical user interface may comprise similar or identical data but in a larger format.

Furthermore, the graphical user interface may comprise an input (e.g., link or icon) on one or more of the screens, which provides the user with access to an application menu. The application menu may comprise selectable options, which provide the user with access to submenus and/or various functions of the application described herein. In addition, the options available through the application menu may change depending on the context of the application (e.g., depending on the current screen being displayed, whether or not the user is logged in, etc.).

1.3.1. User Registration

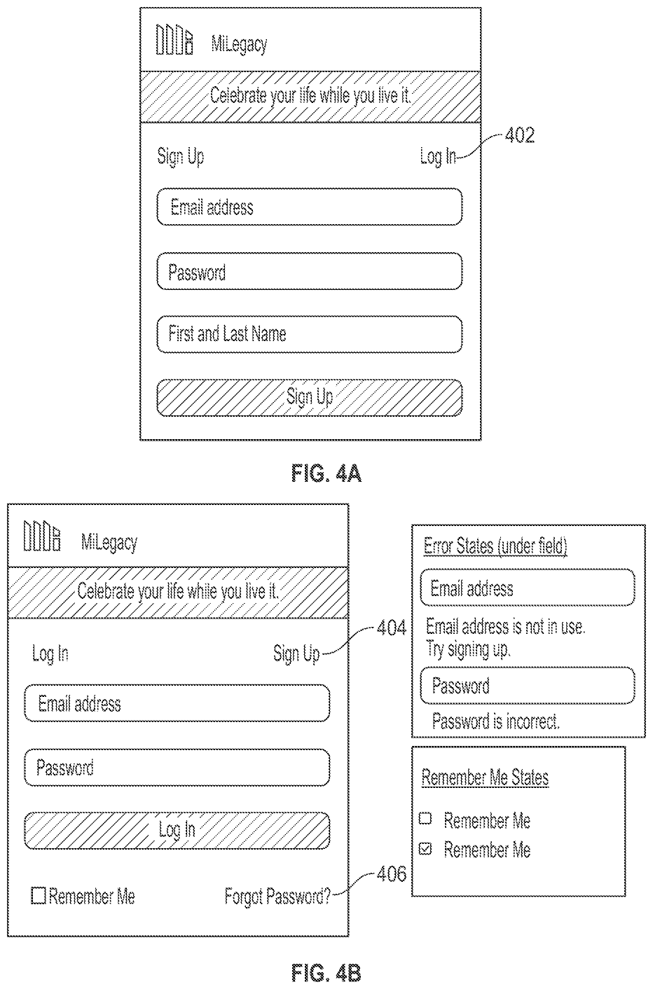

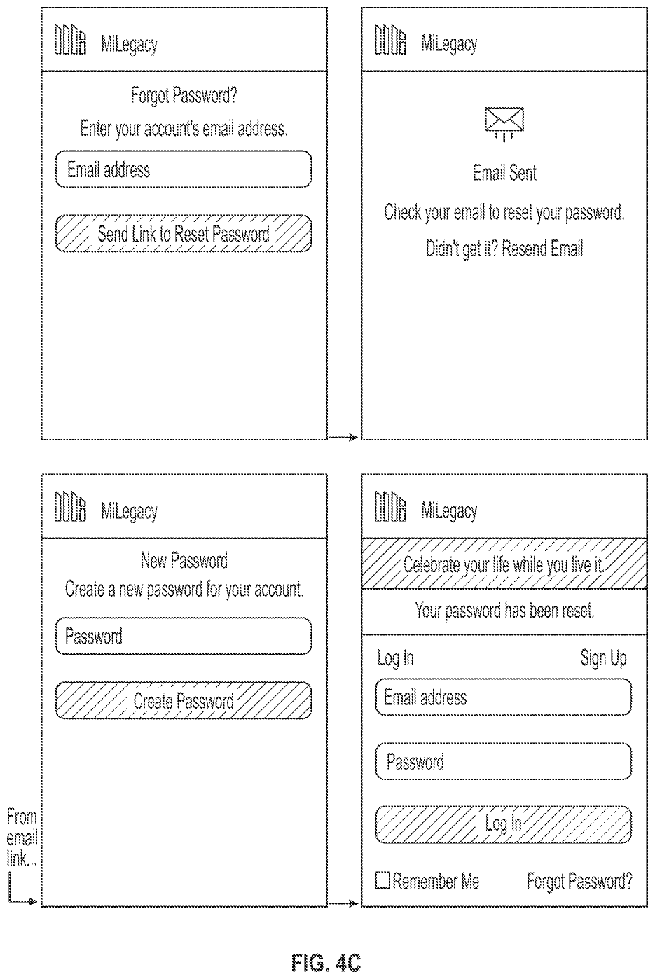

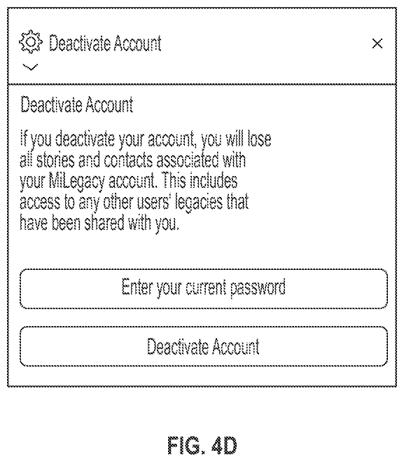

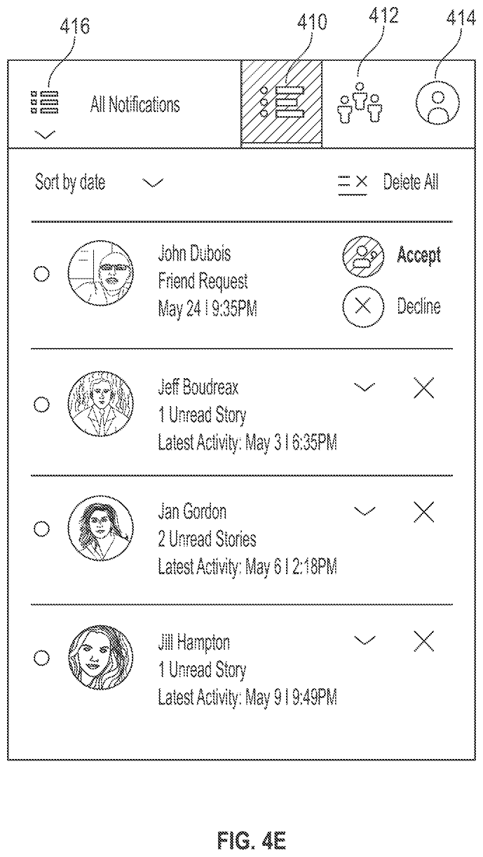

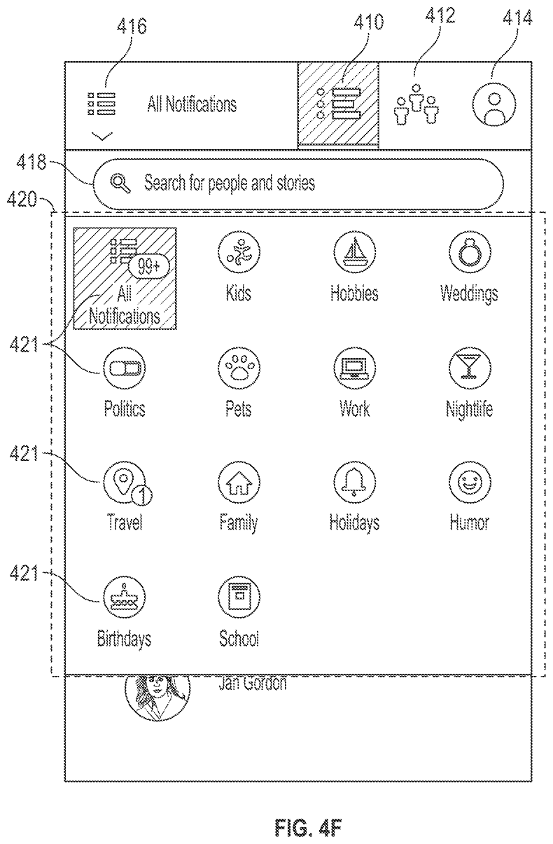

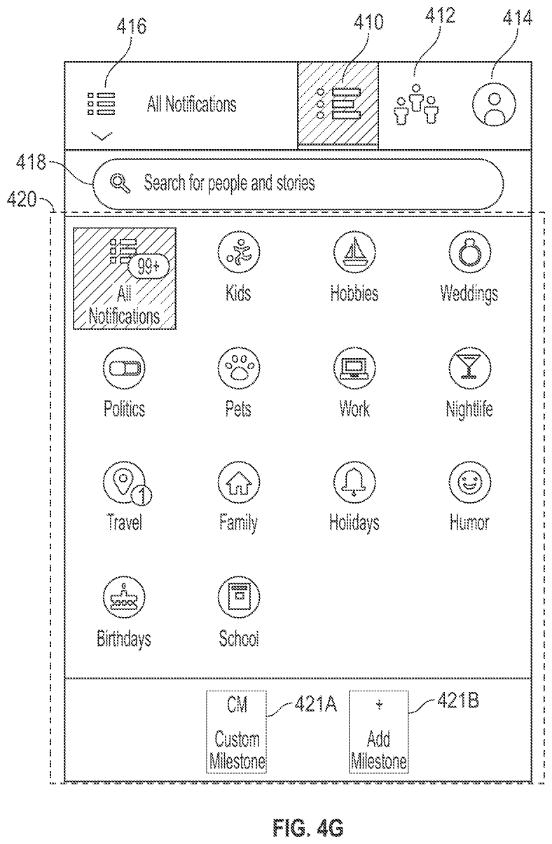

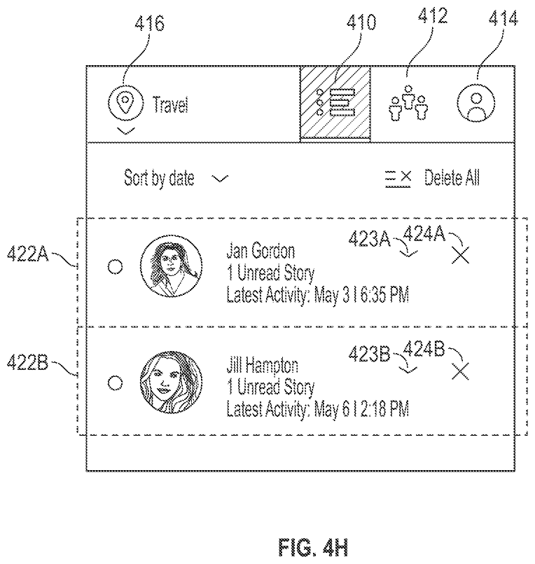

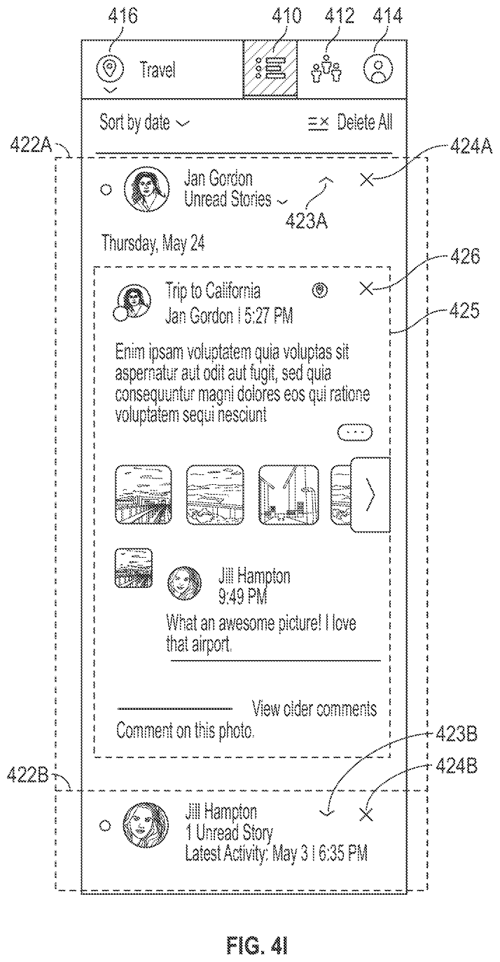

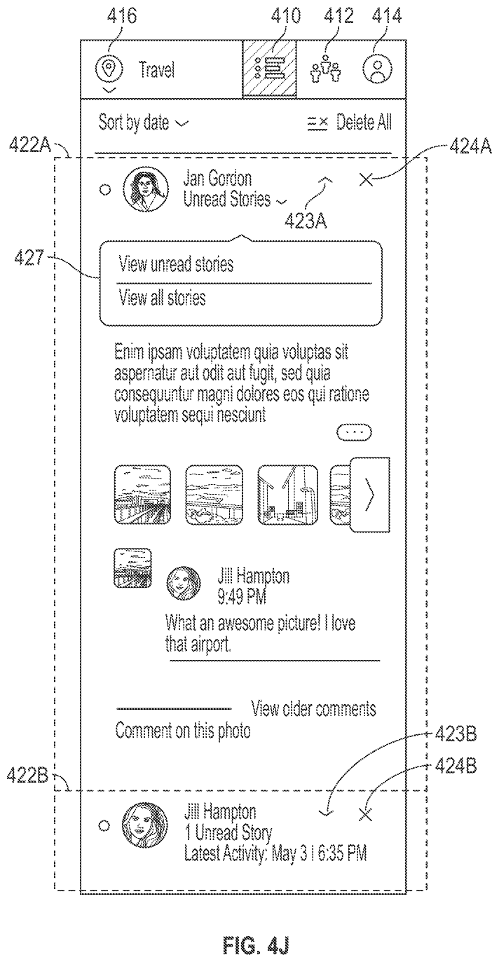

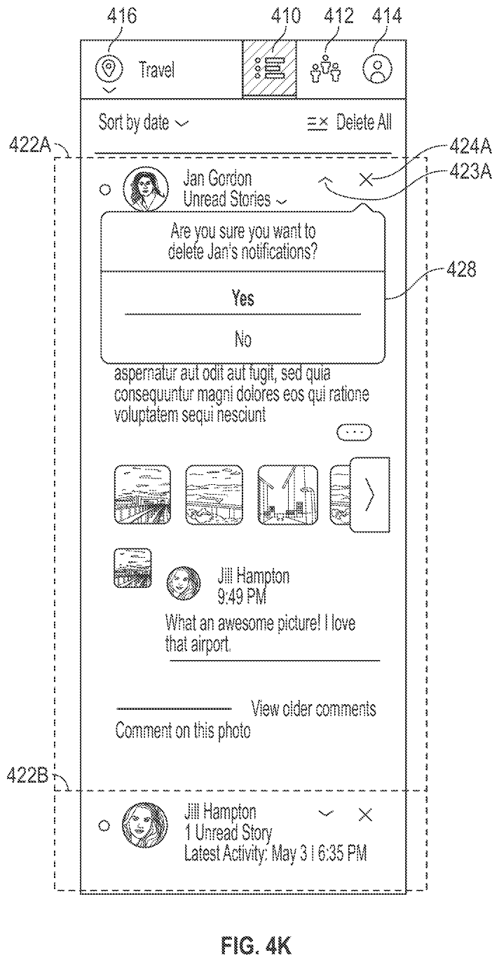

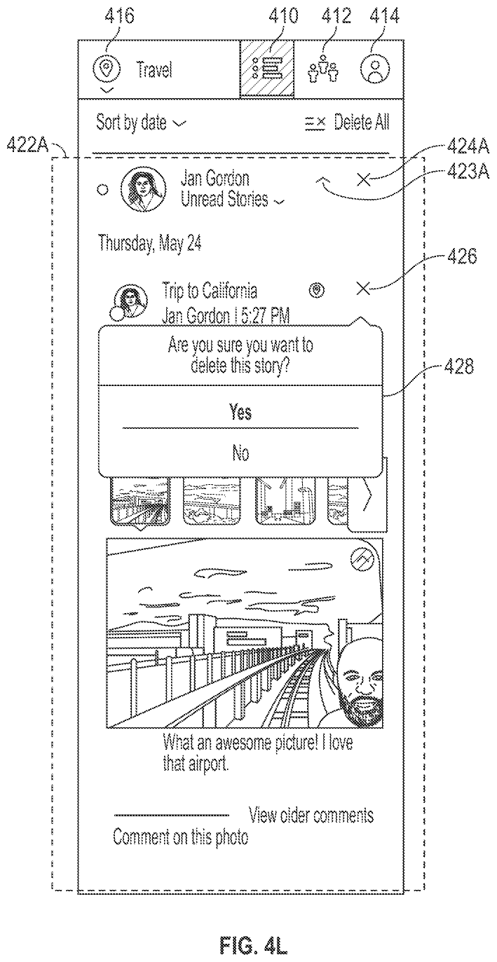

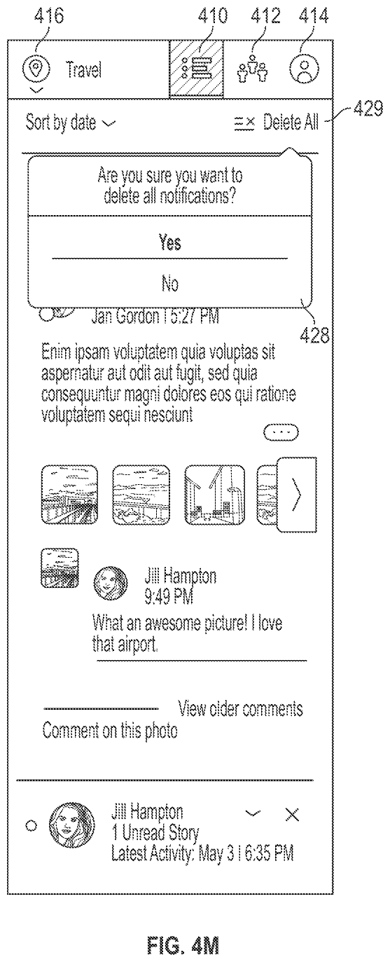

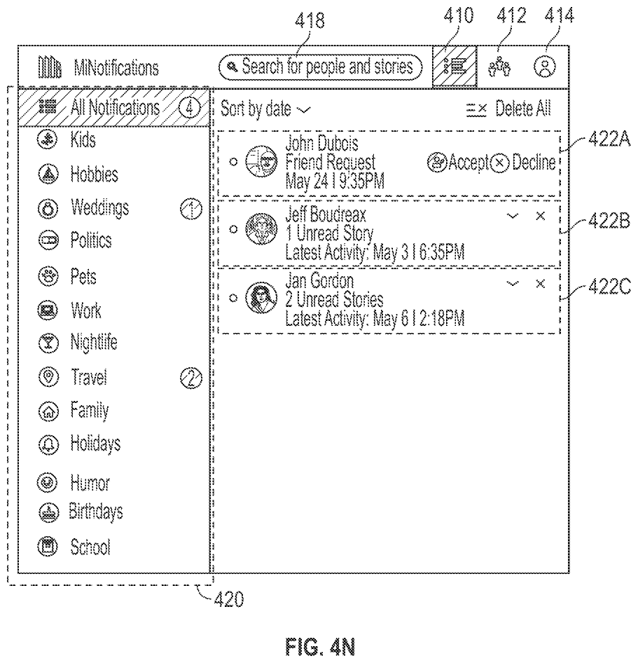

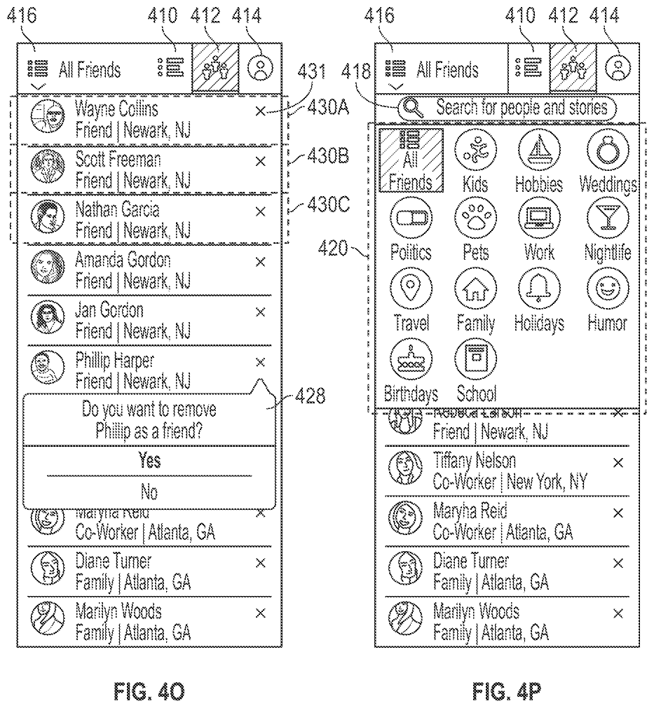

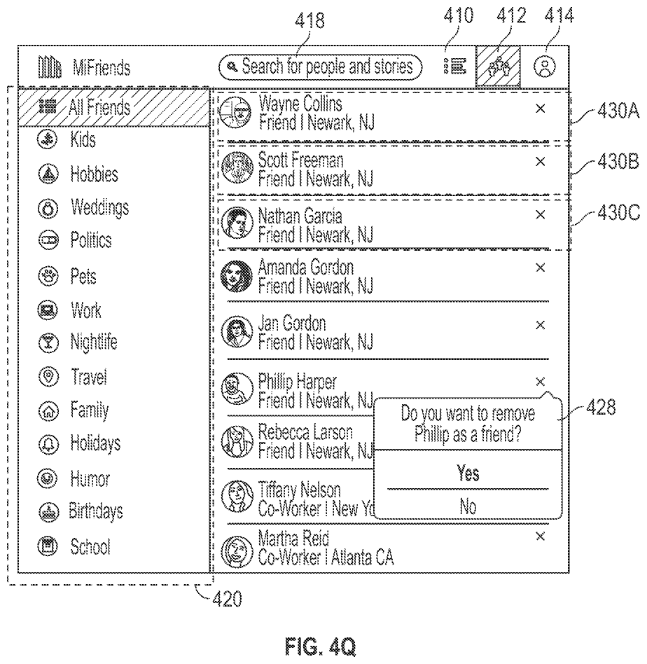

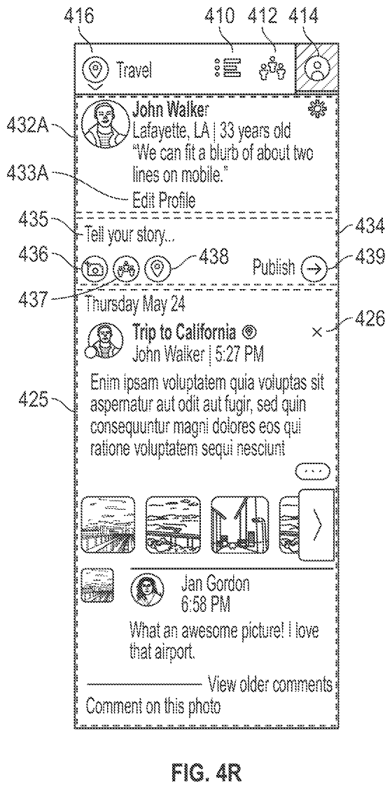

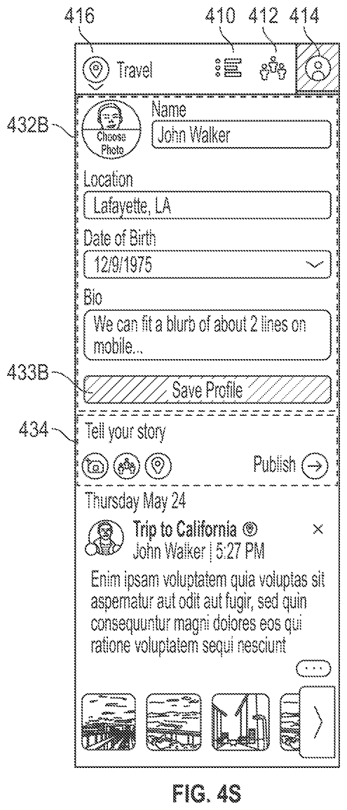

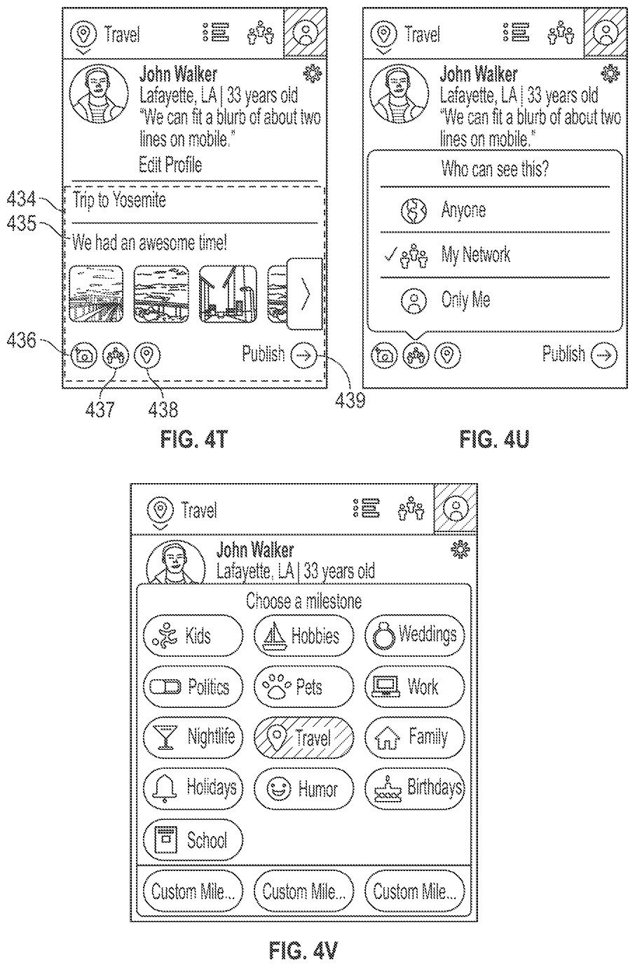

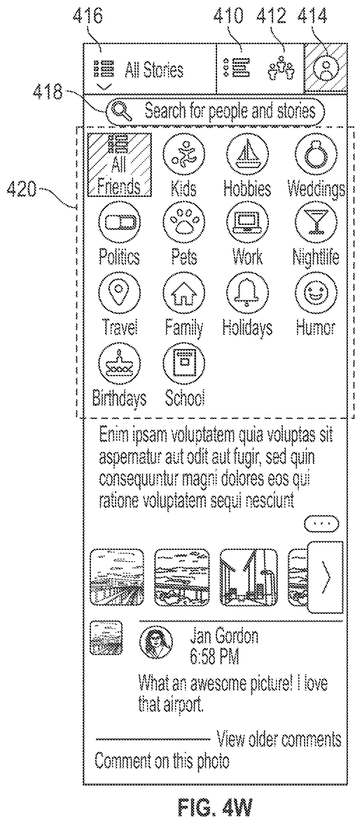

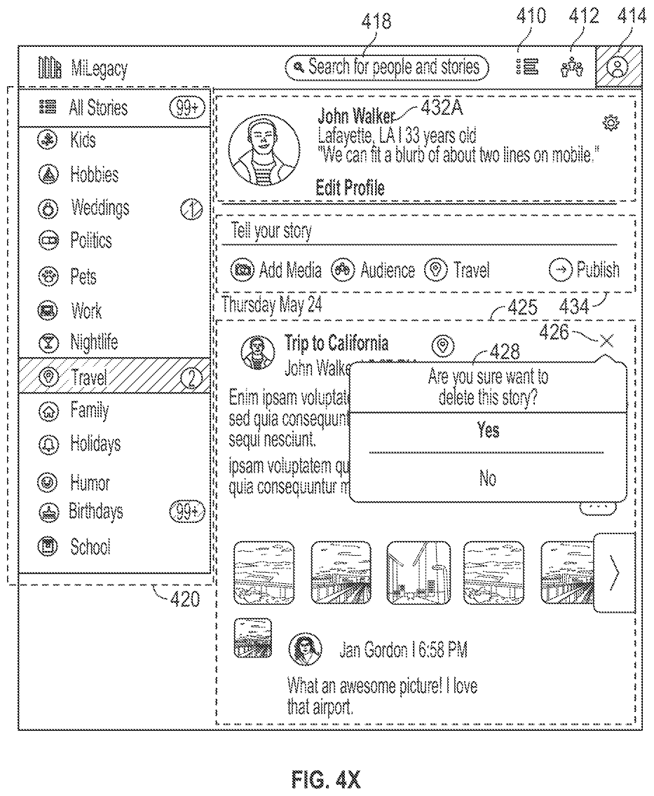

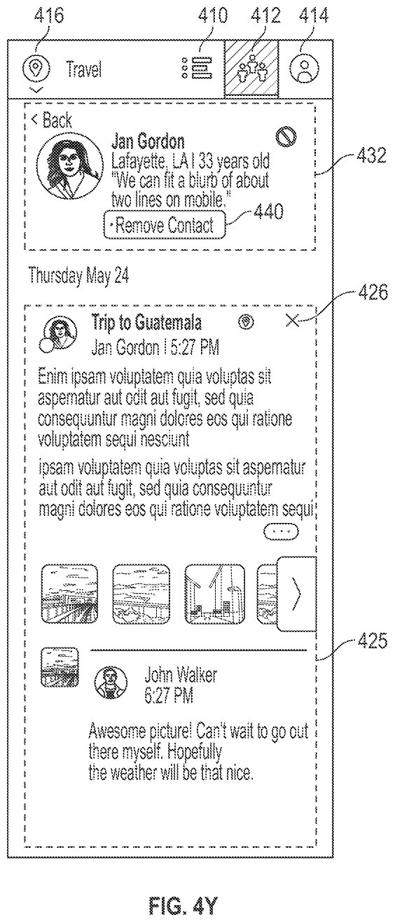

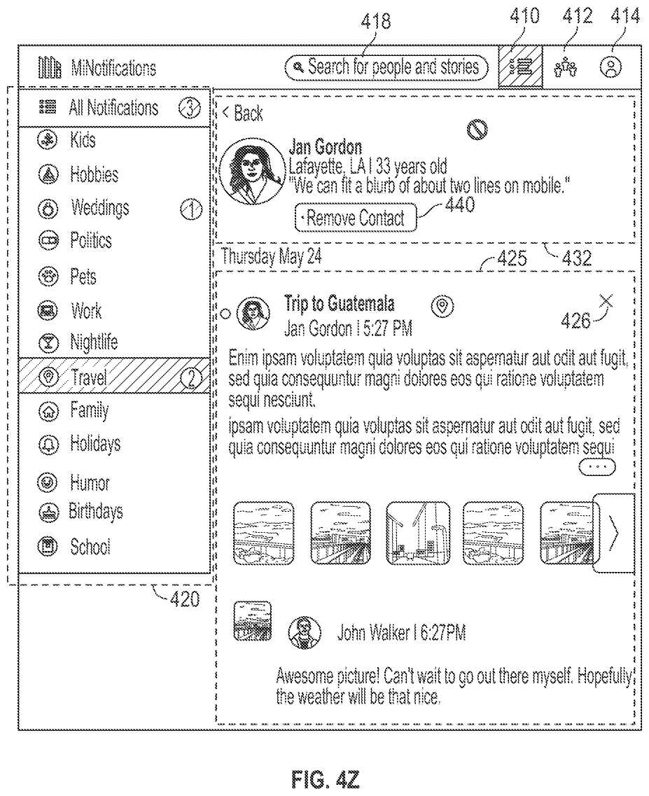

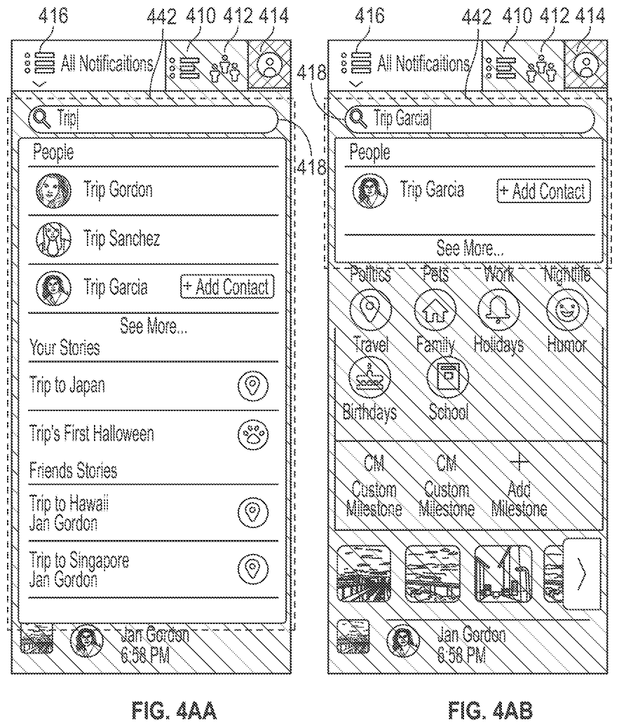

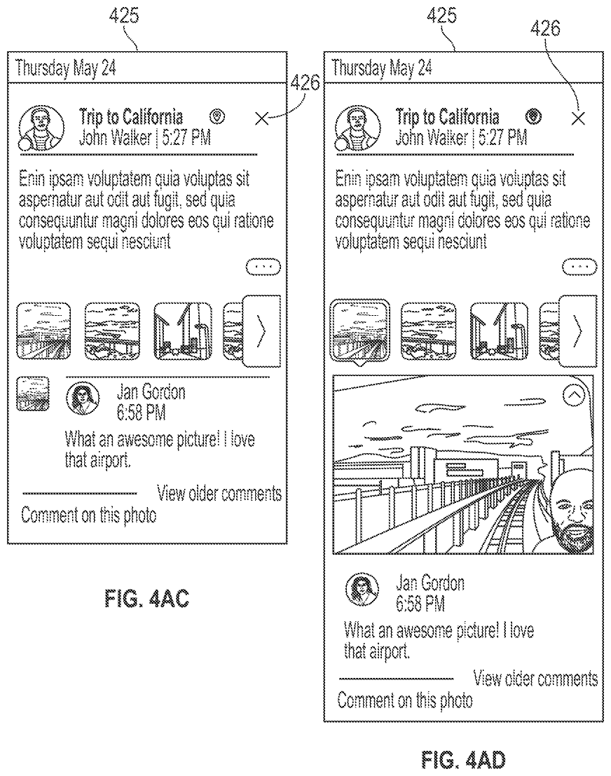

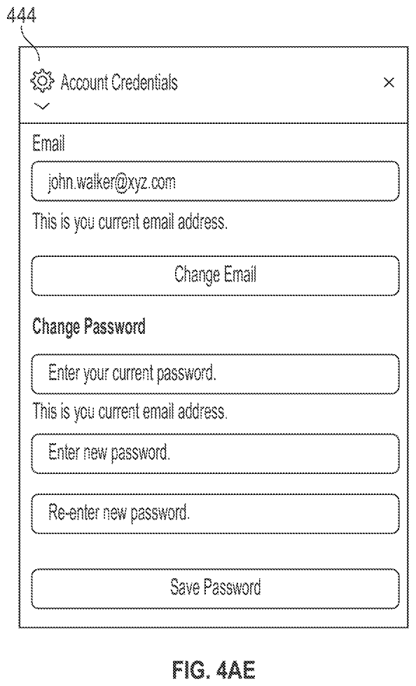

Sign-up module 310 provides functions and screens for a non-user of the application to establish an account with the application to become a user of the application. FIG. 4A illustrates a sign-up screen, according to an embodiment. As illustrated, the sign-up screen comprises a link 402 to a login screen (e.g., illustrated in FIG. 4B). In an embodiment, the sign-up screen can take the form of a wizard that walks the user through the registration process, such as entering information that will form the user's login credentials (e.g., email address, password, etc.), profile (e.g., first name, last name, location, etc.), settings, preferences, defaults, and/or the like.

Login module 312 provides functions and screens for a user of the application to log in to the application. FIG. 4B illustrates a login screen and associated input states, according to an embodiment. As illustrated, the login screen comprises a link 404 to the sign-up screen (e.g., illustrated in FIG. 4A) and a link 406 to a forgot-password screen (e.g., illustrated in FIG. 4C) for recovering or resetting the user's password.

Once logged in, a user may have access to a plurality of screens, which may be arranged in a tab format. In one embodiment, the tabs may comprise a notifications tab 410, which links to screens of notifications module 320, a contacts tab 412, which links to screens of contacts module 330, and a legacy tab 414, which links to screens of legacy module 340. The user may easily navigate between screens of the graphical user interface by simply selecting the desired tab. However, it should be understood that additional or alternative manners of navigation are possible.

Password-retrieval module 314 provides functions and screens for a user of the application, who is not logged in and has forgotten his or her password, to reset his or her password. FIG. 4C illustrates the screens and process for resetting a user's password, according to an embodiment. As illustrated, a first screen comprises inputs for submitting the user's email address (which may be used as the user's username). Once the email address is submitted, an email is sent to the user's email address and a second screen, comprising a notification that the email has been sent, is displayed. The email may comprise a link, which the user can select to be directed to a third screen which comprises inputs for submitting a new password. Once the new password is submitted, the user's password is changed, and the user is returned to the login screen with a notification that the user's password has been successfully changed.

In an embodiment, a user may deactivate their account (e.g., via selection of a deactivation option in the application menu). FIG. 4D illustrates a deactivation screen, according to an embodiment. As illustrated, the user, who must already be logged in to his or her account in an embodiment, may be informed of the consequences of deactivation (e.g., losing all content and contacts associated with the user's account), and required to reenter his or her password and select a deactivation input. The user may also be required to provide other confirmation (e.g., in response to a further prompt and/or by selection of an emailed deactivation link after the deactivation input is selected).

Non-user module 316 provides functions and screens that are available to non-users (or users who are not logged in). For instance, non-users may be permitted to view public content items (e.g., stories) and user profiles.

1.3.2. Notifications

Notifications module 320 provides functions and screens for a user to review and interact with notifications from other users.

FIG. 4E illustrates the main notification screen, according to an embodiment. As illustrated, the main notification screen comprises tabs 410, 412, and 414 in the upper right corner (of which the notifications tab 410 is currently selected), an input 416 to open an application menu (e.g., a drop-down menu overlay comprising one or more inputs for selecting a topic or “milestone”) in the upper left corner, and a list of notifications. The notifications list may include entries for contact requests from other users (e.g., with inputs for accepting or declining the contact request), stories posted by other users (e.g., with inputs for removing the notification from the main notification screen and/or other options), the status of contact requests from the current user to other users (e.g., when the contact request has been approved by the other user), and/or the like.

FIG. 4F illustrates a topic screen 420 as an overlay that expands over an existing screen (e.g., in response to user selection of input 416), according to an embodiment. In the illustrated case, the existing screen happens to be the notifications screen. Topic screen 420 may comprise an input 418 for searching contacts and stories (e.g., a textbox into which a user may input one or more search terms). Topic screen 420 may also comprise inputs 421 for selecting a topic (also referred to herein as a “milestone”). The selectable topics may include all topics (i.e., representing all topics collectively), kids, hobbies, weddings, politics, pets, work, nightlife, travel, family, holidays, humor, birthdays, school, and/or the like. If a user selects a topic, only notifications (e.g., stories) associated with that topic may be listed in the main notification screen. If no specific topic is selected or all topics are selected (e.g., via the “all” input), the main notification screen may list all notifications, regardless of topic or for a set of one or more default topics (e.g., set according to a user preference). In an embodiment, a user may select one or multiple topics from the topic screen. In an embodiment, the non-mobile version of the graphical user interface may comprise the topic screen as a permanent fixture (e.g., as a vertical menu on a left side of one or more or all of the screens), rather than as an overlay.

FIG. 4G illustrates a topic screen 420 which enables customization of topics, according to an embodiment. As illustrated, the bottom of topic screen 420 comprises an input 421A that enables a user to create a custom topic and/or an input 421B that enables a user to add a topic.

FIG. 4H illustrates the main notification screen after a user has selected the “travel” topic in the topic screen 420 illustrated in FIG. 4F or 4G. After the selection of a particular topic, only those content items associated with the selected topic are included in the notifications list. In the illustrated case, only stories associated with the “travel” topic are included in the notifications list.

In an embodiment, the notifications list may comprise expandable entries for each contact associated with at least one notification in the notifications list. For example, as illustrated, the notifications list initially comprises a single expandable entry 422 for each contact. The entry may be expanded by selecting an expansion input 423 for a particular contact entry, and deleted by selecting a deletion input 424 for a particular contact entry.

FIG. 4I illustrates an expanded contact entry 423A in the notifications list, according to an embodiment. As shown, expanded contact entry 423A comprises all content items 425 (e.g., stories) from that contact that are being notified to the current user (e.g., that have not been previously read and, if a topic has been selected, which are associated with the selected topic).

As illustrated in FIG. 4J, according to an embodiment, a user may select a drop-down menu 427 from a contact entry 422 in the notifications list to select whether to “view unread stories” from that contact or “view all stories” from that contact. It should be understood that, if “view unread stories” is selected, only stories which have not been previously read by the current user will be displayed in expanded contact entry 422A. In addition, drop-down menu 427 may comprise an option to only view stories with new comments (e.g., previously read stories with unread comments).

In an embodiment, each contact entry 422 and each content item 425 within each contact entry 422 may be associated with a delete input 424 and 426, respectively, which allows a user to delete that contact entry 422 or content item 425 from the user's notifications list. Thus, a user may delete all content items 425 from a particular contact (e.g., by deleting the contact entry 422) or individual content items 425 from a particular contact (e.g., by deleting just the content item 425 from the expanded contact entry 422A). FIG. 4K illustrates the main notification screen, after the user has selected a delete input 424A for a particular contact entry 422A in the notifications list, according to an embodiment. Similarly, FIG. 4L illustrates the main notification screen, after the user has selected a delete input 426 for a particular content item 425 within an expanded contact entry 422A in the notifications list, according to an embodiment. As illustrated, in both cases, a pop-up overlay 428 may prompt the user to confirm that the user wishes to delete the contact entry 422 or content item 425 from the user's notifications list. If confirmed, the particular contact entry 422 or content item 425 is removed from the user's notifications list. In an embodiment, deleting a particular contact entry 422 or content item 425 for a particular contact does not prevent future content items 425 by that contact from appearing in the user's notifications list. It should be understood that, in the event that all content items 425 within a particular contact entry 422 are deleted, the contact entry 422 may also be deleted from the notifications list.

FIG. 4M illustrates the main notification screen, after the user has selected a “delete all” input 429 for the notifications list. As illustrated, a pop-up overlay 428 may prompt the user to confirm that the user wishes to delete all notifications in the notifications list. If confirmed, all notifications (i.e., all contact entries 422) in the notifications list will be deleted. However, it should be understood that, in the future, new notifications will continue to appear in the notifications list.

FIG. 4N illustrates the main notification screen in a non-mobile version of the application, according to an embodiment. As illustrated, the non-mobile version of main notification screen comprises the same elements as the mobile version of the main notification screen, but without the need for the collapsibility and expandability of topic screen 420.

In an embodiment, notifications module 320 works in conjunction with contact requests module 322 to approve requests to establish a new contact. For example, if another user requests to establish a contact with the current user, the request may appear in the current user's notifications lists with inputs for accepting or declining the request. If the current user accepts the request, a relationship may be established between the current user and the requesting user within their respective social networks. On the other hand, if the current user declines the request, no such relationship is established, and, optionally, the requesting user may be notified. In an embodiment, contact requests may specify a particular relationship to be established with the current user (e.g., a particular type of familial relationship, a friendship, a coworker relationship, etc.).

1.3.3. Contacts

Contacts module 330 provides functions and screens for a user to review and manage the user's contacts and navigate to other users in the user's social network. As used herein, the term “contact” may refer to another user with any relationship to a current user within that current user's social network. However, in one embodiment, for simplicity, all relationships may be referred to as a “friend” relationship, as is common in existing social media platforms (e.g., Facebook™).

In an embodiment, contacts module 330 works in conjunction with contact requests module 322 to send requests to establish a new contact from the current user to another user. The request may appear in the other user's notifications list, and be accepted or declined as discussed elsewhere herein.

FIG. 4O illustrates the main contacts screen of contacts module 330, according to an embodiment. As illustrated, the main contacts screen comprises tabs 410, 412, and 414 in the upper right corner (of which the contacts tab 412 is currently selected), an input 416 to open the application menu in the upper left corner, and a list of contacts. A contact is simply another user with an established relationship to the current user.

The list of contacts comprises an entry 430 for each contact. Each contact entry 430 in the contacts list may be associated with a delete input 431. If delete input 431 for a particular contact entry 430 is selected, as illustrated in FIG. 4O, a pop-up overlay 428 may prompt the user to confirm that the user wishes to delete the contact. If confirmed, the relationship between the current user and the selected contact, within at least the current user's social network, will be severed.

FIG. 4P illustrates a topic screen 420 as an overlay that expands over the contacts screen, according to an embodiment. Topic screen 420 is similar or identical to the topic screen 420 illustrated in FIGS. 4F and 4G.

FIG. 4Q illustrates the contacts screen in a non-mobile version of the application, according to an embodiment. As illustrated, the non-mobile version of main contacts screen comprises the same elements as the mobile version of the main contacts screen, but without the need for the collapsibility and expandability of topic screen 420.

1.3.4. Legacies

Legacy module 340 provides functions and screens for a user to review and add to the user's own legacy. As used herein, the term “legacy” refers to a collection of content items, such as a collection of stories.

FIG. 4R illustrates the main legacy screen of legacy module 340, with the “travel” topic selected, according to an embodiment. As illustrated, the main legacy screen comprises tabs 410, 412, and 414 in the upper right corner (of which legacy tab 414 is currently selected), an input 416 to open the application menu in the upper left corner, and a list of content items (e.g., stories). Each content item 425 in the list may be associated with a delete input 426. If delete input 426 for a particular content item 425 is selected, a pop-up overlay may prompt the user to confirm that the user wishes to delete the content item. If confirmed, the associated content item 425 will be deleted from the user's legacy.

In an embodiment, legacy module 340 works in conjunction with profile module 380 to manage a user's profile. For example, as illustrated in FIG. 4R, the legacy screen may comprise the user's profile or a synopsis of the user's profile 432A, along with an input 433A for editing the user's profile. The user's profile comprises a collection of information about the user. For example, this information may comprise the user's full name, city and state of residence, age, a statement (e.g., biography, status, inspirational quote, etc.) from the user, and/or the like.

If the input 433A for editing the user's profile is selected, the user's profile, displayed in the legacy screen, may become editable, as illustrated by the user's profile 432B in FIG. 4S, according to an embodiment. If changes are made to the user's profile 432B, the user can save the changes by selecting the save input 433B illustrated in FIG. 4S.

In an embodiment, the legacy screen comprises one or more inputs 434 for creating a new content item (e.g., story). As illustrated in FIG. 4R, these inputs comprise a text input 435 for inputting text (e.g., a story narrative), a media input 436 for inserting media (e.g., photograph or other image, video, etc.) into the content item, a privacy input 437 for selecting contacts with whom to share the content item, a topic input 438 for selecting a topic to be associated with the content item, and a publish input 439 for publishing the content item (i.e., adding the content item to the user's legacy). As shown, if a topic has been selected from topic screen 420, topic input 438 may default to the selected topic.

FIGS. 4T-4V illustrate the creation of a content item, according to an embodiment. As illustrated in FIG. 4T, a user may input a title and description for a memory related to travel (e.g., “Trip to Yosemite” and “We had an awesome time!” via text input 435). The user may also insert media via in-feed uploader module 342 (e.g., by selecting media input 436), which facilitates the selection and uploading of media, such as images or video. As illustrated in FIG. 4U, a user may select a privacy setting for the content item (e.g., by selecting privacy input 437). The privacy setting may represent a group of users. For example, a privacy setting of “anyone” may set the content item as public (i.e., viewable by any user and/or non-user), a privacy setting of “my network” may set the content item as viewable only by the current user's contacts, and a privacy setting of “only me” may set the content item as viewable only by the current user. While not illustrated, the privacy setting may also include other options, such as a subset of the user's contacts (e.g., a group of contacts who are family of the user, a group of contacts who are friends of the user, a group of contacts who are coworkers or clients of the user, a custom group of contacts created by the user, etc.). The default privacy setting may be to set the content item as viewable only by the current user's contacts. As illustrated in FIG. 4V, the user may also select a topic (e.g., via topic input 438). If a topic has already been selected via topic screen 420, the default topic for a content item being created may be the selected topic. After inserting text, media, and/or selecting the desired options (e.g., privacy setting and topic) for a content item being created, the user can publish the content item (e.g., by selecting publish input 439). The content item will then be added to the user's legacy. Furthermore, if the privacy setting includes all or a subset of the user's contacts, an entry for the content item may appear in each of those contacts' notification lists (e.g., as a content item 425 within a contact entry 422).

FIG. 4W illustrates topic screen 420 as an overlay that expands over the legacy screen, according to an embodiment. FIG. 4X illustrates the legacy screen in a non-mobile version of the application, according to an embodiment.

In an embodiment, a user can view, not only his or her own legacy, but other users' legacies (e.g., contacts' legacies, public stories, etc.). Other's legacy module 350 provides functions and screens for a user to view another user's legacy.

FIG. 4Y illustrates another user's legacy screen in a mobile version of the application, according to an embodiment. FIG. 4Z illustrates another user's legacy screen in a non-mobile version of the application, according to an embodiment. The other user's legacy screen is similar to the own user's legacy screen in FIGS. 4R and 4X, but does not include an input 433A for editing the profile 432 of the user associated with the legacy or an input 434 for creating a new content item.

In addition, the other user's legacy screen may comprise an input 440 for adding or removing the user as a contact. This input may work in conjunction with contact request module 322 to manage the other user as a contact of the current user. For example, if the other user is not already a contact, selection of this input will send a request to establish contact from the current user to the other user. While the request is pending, the input may be non-selectable and/or indicate that approval of the request is pending. Once the other user has approved the request, a relationship between the current user and the other user may be established in both users' social networks. In addition, once the other user has approved the request, the input 440 may be selectable once again, but may be changed to an input for severing the contact. If the input for severing the contact is selected, the relationship between the users may be severed in one or both users' social networks, such that the other user will no longer appear in the current user's contacts list and possibly vice versa.

The other user's legacy screen may comprise delete inputs 426 associated with each content item 425 in the other user's legacy. However, unlike with the user's own legacy screen, if a delete input 426 is selected, the associated content item 425 is not deleted from the other user's legacy. Rather, the selected content item 425 will simply be deleted from the current user's view of the other user's legacy. In other words, the current user will no longer see that content item 425 when viewing the other user's legacy and in the current user's notifications list. Other users will continue to see that content item 425 when viewing the other user's legacy and in their respective notifications lists.

1.3.5. Search

Search module 360 provides functions and screens for a user to search users and/or content items (e.g., stories). In an embodiment, search module 360 may work in conjunction with one or more of notifications module 320, contacts module 330, legacy module 340, and other's legacy module 350.

FIGS. 4AA and 4AB illustrate a search screen 442 as an overlay that expands over an existing screen, according to an embodiment. Search screen 442 may be part of the same overlay as topic screen 420, described elsewhere herein. In the illustrated case, the existing screen happens to be the notifications screen.

In an embodiment, search screen 442 comprises a text-based search input 418 for inputting search terms. In an embodiment, the non-mobile version of the application may comprise search input 418 as a permanent fixture (e.g., horizontally along the top of one or more or all of the screens), rather than as an overlay. As characters are typed into search input 418 a variable-sized list of predictive search results may be populated near search input 418 in real time. For example, as illustrated in FIG. 4AA, based on the search term “Trip”, which has been input into the text input, a list of users, having a name that contains the character string “trip”, and content items, tagged with the terms containing the character string “trip”, are predictively displayed as selectable entries underneath search input 418. Entries in the list of predictive search results may be distinguished by type (e.g., user, current user's content item, other user's content item, etc.), comprise a short description (e.g., a name for a user, or a title and topic for a content item), and/or an input (e.g., an input to request to establish contact with a user who is not already a contact). The number of entries in the predictive search results may be limited to a predetermined number and/or a predetermined number per type of entry, with input(s) for viewing more predictive search results beyond the predetermined number. As illustrated in FIG. 4AB, the list of predictive search results will narrow down, in real time, as a user continues to type characters into the text input.

Each entry in the list of predictive search results may be selectable. For example, if the current user selects an entry for a user, the current user may be directed to a legacy screen for the selected user (e.g., as provided by other's legacy module 350). On the other hand, if the user selects an entry for a content item, the user may be directed to a screen containing that content item.

1.3.6. Content Items

In an embodiment, each content item 425 in a user's legacy takes the form of a “story,” representing a memory managed by stories module 370 and in-story lightbox module 372. Each story may comprise elements, such as a title, description (e.g., narrative of the story), topic, and/or one or more media (e.g., photographs or other images, video, animations, emoji, electronic documents, etc., related to the story). The arrangement of elements within the story may be common for all stories (e.g., using a common template), or may be configurable by the user (e.g., using a custom template).

In addition, comments may be attached to a story. In an embodiment, the comments may be arranged hierarchically to include, for example, comments on the story, comments or replies to other comments, comments or replies to comments or replies to other comments, and so on. As comments are submitted for a story, those comments may be notified in the notifications list of the user to whose legacy the story belongs.

FIGS. 4AC and 4AD illustrate an example story 425 in a collapsed form and expanded form, respectively. Stories may appear in similar or identical forms in the notification screens and legacy screens. Initially, a story may appear in its collapsed form, as illustrated in FIG. 4AC. As illustrated, the story may comprise a title, an indication of the associated topic, a delete input 426 for deleting the story, a name and image of the user to whose legacy the story belongs, a day and/or time at which the story was published, an indication of whether or not the story has been previously read by the current user, a description or narrative, a thumbnail for one or more media with an indication to swipe for additional thumbnails if necessary, a list of comments (e.g., each comprising an image and name of the commenter, a time at which the comment was submitted, and the comment), an input for viewing more comments if necessary, and an input for adding a comment.

In an embodiment, when a user selects the thumbnail of a medium (e.g., photograph) within the story, the story region 425 may be expanded to include a larger version of the selected medium, highlight the selected thumbnail, and include an icon for collapsing the story region 425 by removing the larger version of the selected medium from the story region 425. This is illustrated in an example in FIG. 4AD.

In an embodiment, when a story 425 is focused upon (e.g., expanded, selected, etc.), the story 425 may appear in a “lightbox,” which is a region that is brighter than the surrounding screen. The lightbox may be implemented by dimming the screen around the story region 425.

1.3.7. Settings

Settings module 390 provides functions and screens for a user to manage settings associated with the user's account. FIG. 4AE illustrates a settings screen, according to an embodiment. As illustrated, the settings screen comprises inputs for a user to change the email address associated with the account (and, for example, used as the username for logging into the account), the user's password, and/or the like.

In an embodiment, the settings screen could also comprise inputs for setting the user's preferences, defaults, and/or the like. Alternatively, as illustrated in FIG. 4AE, the settings screen may comprise a link 444 to a drop-down menu overlay in the upper left corner that provides links to other settings screens (e.g., for setting preferences, defaults, etc.).

2. Process Overview

Embodiments of processes for managing a media archive representing personal memories will now be described in detail. It should be understood that the described processes may be embodied in one or more software modules that are executed by one or more hardware processors (e.g., processor 210), e.g., as the application discussed above (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130 such that some portions or modules of the application are executed by platform 110 and other portions or modules of the application are executed by user system(s) 130. The described processes may be implemented as instructions represented in source code, object code, and/or machine code. These instructions may be executed directly by the hardware processor(s), or alternatively, may be executed by a virtual machine operating between the object code and the hardware processors. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

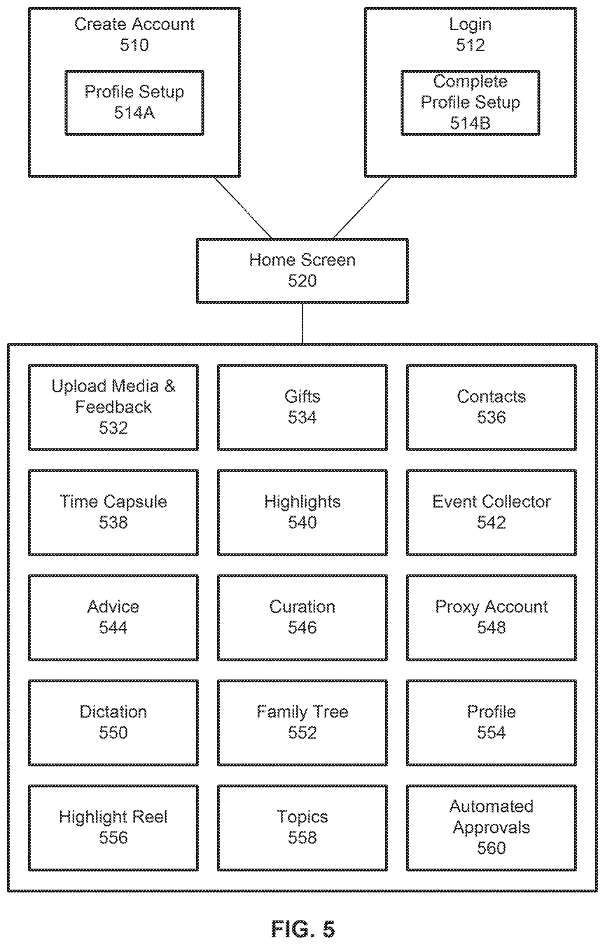

FIG. 5 illustrates various processes that may be implemented by the disclosed application. Specifically, the application may comprise one or more software modules that perform a create-account process 510, a login process 512, a profile-setup process 514A, a complete-profile-setup process 514B, a home-screen process 520, an upload-media-and-feedback process 532, a gifts process 534, a contacts process 536, a time-capsule process 538, a highlights process 540, an events-collector process 542, an advice process 544, a curation process 546, a proxy-account process 548, a dictation process 550, a family-tree process 552, a profile process 554, a highlight-reel process 556, a topics process 558, and/or an automated-approvals process 560. While various processes will be described and/or illustrated herein as having a certain arrangement of steps, it should be understood that each of these processes may be implemented with more, fewer, or a different arrangement of steps than those described or illustrated. In addition, these processes may be implemented by server application 112 on platform 110.

2.1. Create Account/Login

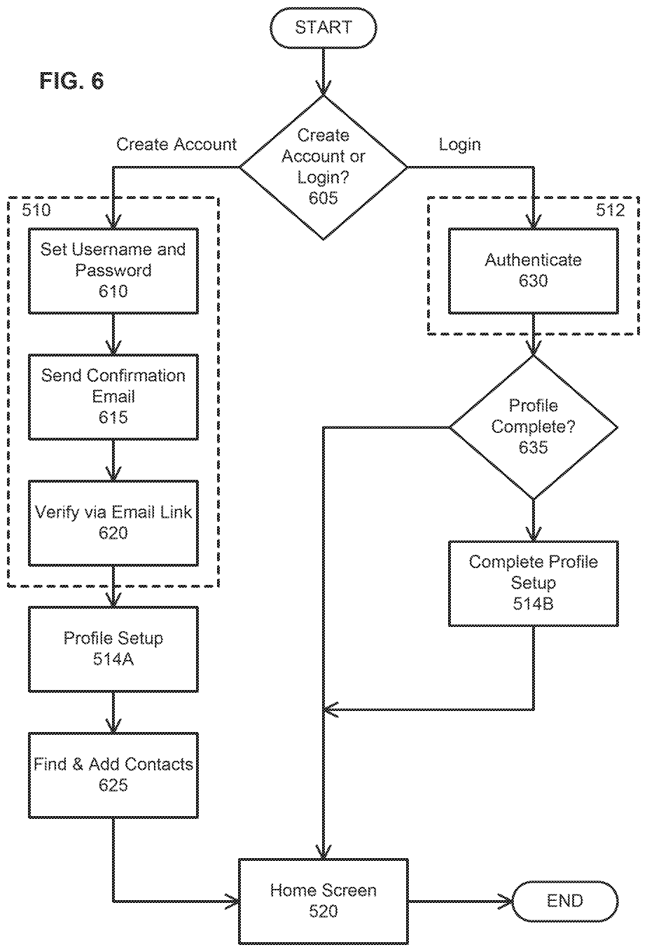

FIG. 6 illustrates create account process 510, login process 512, profile setup process 514A, and complete profile setup process 514B, according to an embodiment.

In step 605, if the initiating operation is to create an account, the process proceeds to step 610. Otherwise, if the initiating operation is to login, the process proceeds to step 630.

In step 610, the user sets a username (e.g., an email address) and password for account authentication, for example, via the sign-up screen illustrated in FIG. 4A. Other information may also be received in step 610, such as the user's name, email address (if not used as a username), and/or the like.

In step 615, the application sends an email to the email address set in step 610. The email may comprise a link for verification of the email address. When the user selects the link in the email, the user may be directed (e.g., via the user's web browser) to a web resource which verifies the email address in step 620 and provides a login screen (e.g., the login screen illustrated in FIG. 4B).

When the user first logs in, the user may be directed through profile setup 514A. For example, the user may be directed to a profile screen which requests information for the user's profile, such as the user's name, address, phone number, date of birth, biography, image (e.g., to be used as the user's avatar), interests, employer, marital status, financial account and/or payment information (e.g., bank account information for direct debits and/or deposits, PayPal™ account information, etc.), and/or the like.

After being directed through profile setup process 514A or if the user chooses to skip profile setup process 514A, the process may direct the user through a process 625 of finding and adding contacts. For example, the user may be directed to a search screen for searching for other users and requesting to establish contacts with those users.

After being directed through processes 514A and 625, the user may be directed to home screen process 520, during which a home screen is displayed to the user.

If the initiating action is to login, in step 630, the user is authenticated. For example, the user may input his or her username and password into the login screen illustrated in FIG. 4B, and the application may match the input password to the password registered for the input username and authenticate the user when the passwords match.

Once authenticated, the application may determine whether or not the user has completed his or her profile. If the user has completed his or her profile (i.e., “YES” in step 635), the user may be directed to home screen process 520. Otherwise, if the user has not completed his or her profile (i.e., “NO” in step 635), the user may be directed through profile setup 514B, which may be similar or identical to profile setup process 514A. The only difference between profile setup process 514A and 514B may be that, in complete profile setup process 514B, the user does not need to re-input information that has already been input in a prior profile setup process 514A or 514B. After being directed through profile setup process 514B or if the user chooses to skip profile setup process 514B, the user may be directed to home screen process 520.

2.2. Home Screen

Home screen process 520 may comprise providing the user with his or her home screen (e.g., the notification screen illustrated in FIG. 4E), and navigation opportunities to other screens (e.g., via tabs 410, 412, and/or 414, via selection of link 416 for the application menu or topic screen 420) and/or other resources.

2.3. Upload Media and Feedback

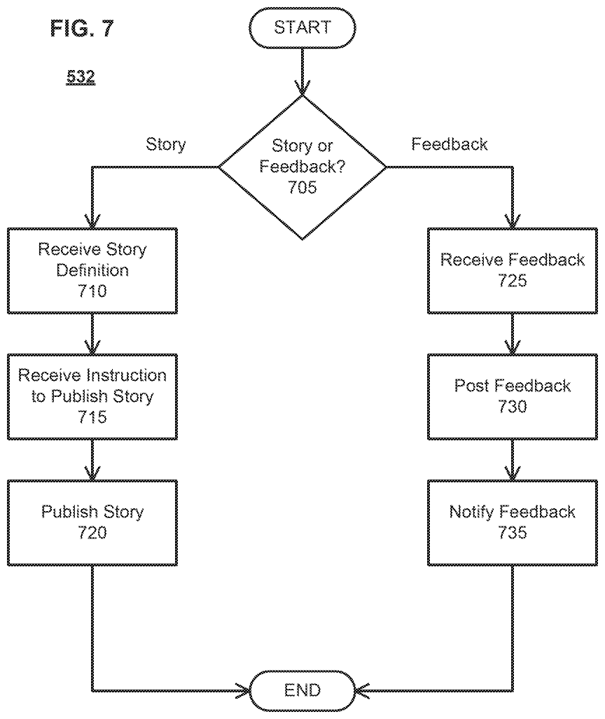

FIG. 7 illustrates upload-media-and-feedback process 532, according to an embodiment. Upload-media-and-feedback process 532 may be used by users to post stories and/or feedback (e.g., comments, ratings, etc.) on stories.

In step 705, if the initiating action is to create a story, the process proceeds to step 710. Otherwise, if the initiating operation is to create feedback, the process proceeds to step 725.

In step 710, the definition of a story is received from a user. For example, the story may be defined through the screens and inputs discussed with respect to FIGS. 4T-4V, and may comprise a title, text, date and/or time, media, privacy setting, topic, and/or the like.

In step 715, an instruction to publish the story is received from the user (e.g., via publish input 439), and, in step 720, the story may be published. Publication of the story may involve adding the story to the creating user's legacy, as well as adding a notification of the story to other users' notification lists according to the privacy setting associated with the story.

If the initiating action is to create feedback, in step 725, the feedback is received. The feedback may comprise a comment to a story and/or a rating of the story (e.g., a “like” of the story, a star-based rating, etc.). In step 730, the feedback is posted (e.g., attached to the story wherever it's been published), and, in step 735, the user whose story is the subject of the feedback may be notified of the posted feedback (e.g., in the user's notifications list).

2.4. Gifts

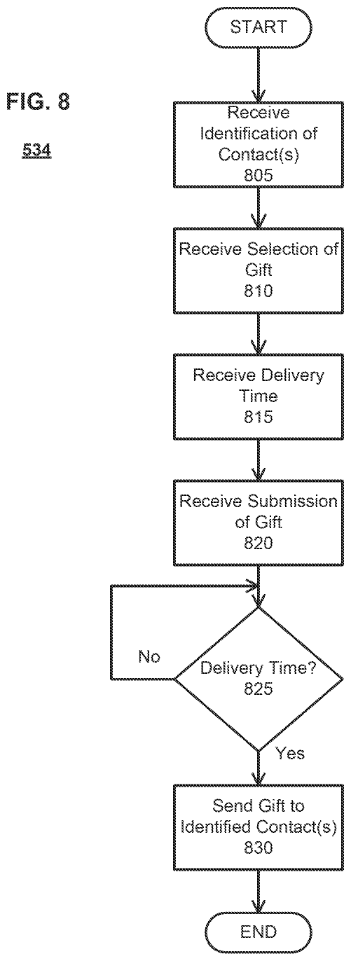

FIG. 8 illustrates gifts process 534, according to an embodiment. Gifts process 534 may be used by users to provide gifts to other users at specified times.

In step 805, one or more contacts are identified as the recipient of a gift. The contacts may be identified, for example, by receiving a selection by a user of one or more contacts within the user's contacts list, such as the contacts list in the contacts screen illustrated in FIG. 4O, or search results.

In step 810, a gift is selected or defined. In an embodiment, a finite number of gifts may be available, and a user may select one or more gifts from a list of available gift types via a screen. Gifts may include a transfer of money (e.g., via electronic money transfer between financial accounts established in the respective user profiles for each of the current user and the recipient contact(s)), a gift card, a product purchased through the app and/or from a third-party service, and/or the like.

In step 815, a delivery time is specified by the user. The delivery time may comprise a future day and/or time or the current time.

In step 820, the gift is submitted, for example, by a user selecting a submission input. In an embodiment, the user may also be prompted to confirm submission of the gift, for example, via a pop-up overlay.

In step 825, process 534 blocks or waits until the specified delivery time. At the delivery time (i.e., “YES” in step 825), process 534 proceeds to step 830. Otherwise, if the delivery time is still in the future (i.e., “NO” in step 825), process 534 continues to wait until the future delivery time. It should be understood that if the user selects the current time, as opposed to a future time, as the delivery time, step 825 is essentially skipped or omitted.

In step 830, the gift, selected or defined in step 810, is sent to the contact(s), identified in step 805, at the delivery time, specified in step 815. The gift may be sent electronically if possible (e.g., via electronic transfer from the gifting user's bank account to the receiving contact(s) bank account(s) if the gift is money, via an email or other electronic notification of a gift code if the gift is a gift card, etc.) and/or physically (e.g., using a shipping service such as the U.S. Postal Service, FedEx™ UPS™ etc., if the gift is a tangible object).

2.5. Contacts

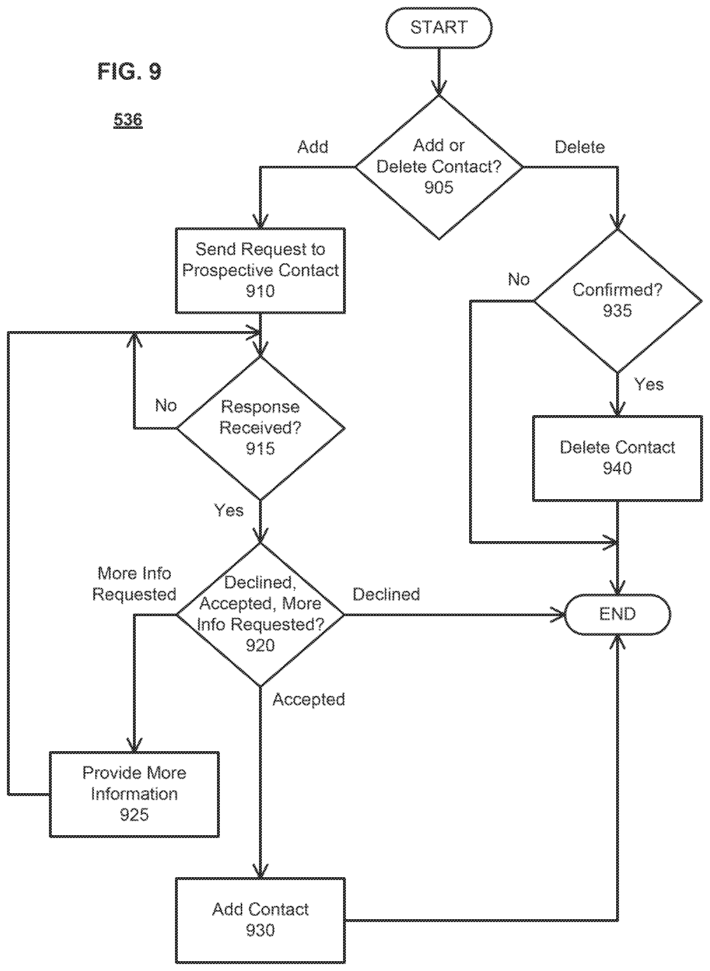

FIG. 9 illustrates contacts process 536, according to an embodiment. Contacts process 536 may be used by users to manage their contacts.

In step 905, if the initiating action is to add a contact (i.e., “Add” in step 905), the process proceeds to step 910. Otherwise, if the initiating operation is to delete a contact (i.e., “Delete” in step 905), the process proceeds to step 935. The addition and deletion of contacts may be initiated via the various “add contact” and “remove contact” inputs (e.g. input 440) or delete inputs (e.g., input 431) illustrated throughout the figures (e.g., in FIGS. 4O, 4Q, 4Y, 4Z, 4AA, and 4AB).

In step 910, if the initiating action is to add a contact, a request to establish the contact is sent to the user selected as a prospective contact. For example, the application may responsively add a notification to the prospective contact's notifications list. The notification may comprise one or more inputs for accepting or declining the request, as illustrated, for example, in FIG. 4E.

In step 915, process 536 blocks or waits until a response to the request, sent in step 910, is received. If a response is received (i.e., “YES” in step 915), process 536 proceeds to step 920. Otherwise, if the response has not yet been received (i.e., “NO” in step 915), process 536 continues to wait.

In step 920, once a response is received, process 536 determines whether the response, received in step 915, is a declination, acceptance, or a request for more information. The response may be received, for example, by the prospective contact selecting an input in a screen of the application (e.g., in an entry of the prospective contact's notifications list, as illustrated in FIGS. 4E and 4N).

If the response is a request for more information (i.e., “More Info Requested” in step 920), more information is provided to the prospective contact in step 925. This information may be sent automatically, for example, using information extracted from the profile of the user who requested to establish the contact. Alternatively, the information may be requested and received from the user who requested to establish the contact (e.g., via a screen), and then forwarded to the prospective contact.

If the response is a declination (i.e., “Declined” in step 920), process 536 ends without establishing the contact. On the other hand, if the response is an acceptance (i.e., “Accepted” in step 920), a relationship is established between the requesting user and prospective contact in their respective social networks in step 930, such that the users are now contacts.

In step 935, if the initiating action is to delete a contact, the user is prompted to confirm the deletion in order to prevent the inadvertent deletion of a contact. If the user cancels the deletion (i.e., “NO” in step 935), process 536 ends without deleting the contact. Otherwise, if the user confirms the deletion (i.e., “YES” in step 935), the relationship between the requesting user and the contact to be deleted is severed in their respective social networks in step 940, such that the users are no longer contacts.

2.6. Time Capsule

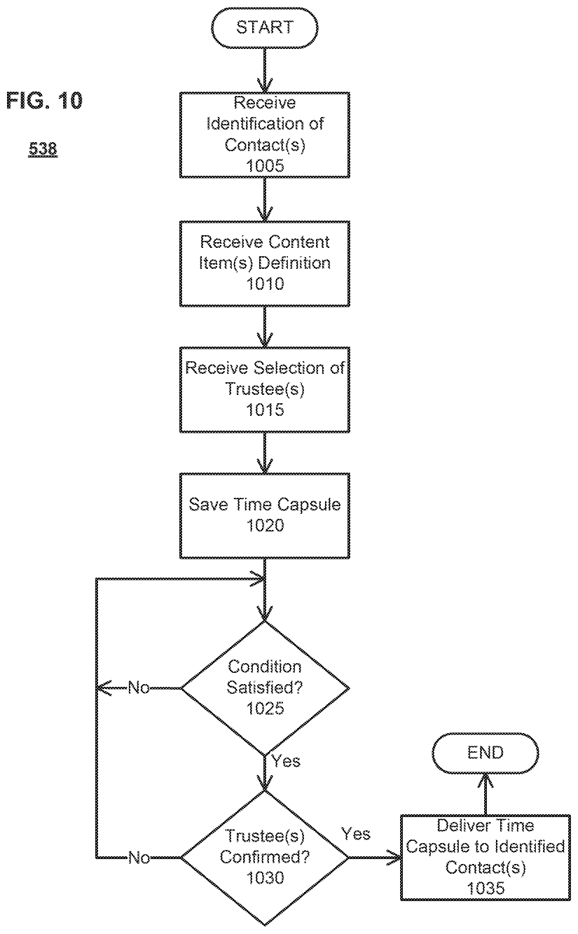

FIG. 10 illustrates time-capsule process 538, according to an embodiment. Time-capsule process 538 may be used by users to create time capsules which “open” (e.g., are delivered to one or more recipients) upon the satisfaction of a condition (e.g., one or more criteria).

In an embodiment, time-capsule process 538 may be initiated by the user's selection of an input in one or more screens (e.g., an input comprising an hourglass icon associated with a story created by the user).

In step 1005, one or more contacts are identified as the recipient(s) of a time capsule. The contacts may be identified, for example, by receiving a selection of one or more contacts within a user's contacts list, such as the contacts list in the contacts screen illustrated in FIG. 4O, or search results.

In step 1010, one or more content items to be placed in the time capsule are defined. For example, a user may create one or more content item(s) to be placed into the time capsule and/or select one or more existing content item(s) to be placed into the time capsule. As discussed elsewhere herein, a content item may be a story, comprising text and media that collectively represent a memory belonging to the user.

In an embodiment, the time capsule may also be defined in step 1010, not only by the content item(s) included in the time capsule, but by a condition upon which the time capsule should be delivered. For example, the user may specify the condition from a plurality of available conditions and/or using a custom condition. Examples of possible conditions include, without limitation, a certain date and/or time, the passage of a certain time period (e.g., ten years), the death of the user, incapacitation of the user, an important event in a recipient contact's life (e.g., birthday, anniversary, graduation, marriage, first child, etc.), and/or the like.

In step 1015, one or more trustees of the time capsule are identified. The trustees may be identified, for example, by receiving a selection of one or more contacts within a user's contacts list, such as the contacts list in the contacts screen illustrated in FIG. 4O. A trustee of the time capsule serves to verify the condition (e.g., specified in step 1010) upon which the time capsule will be delivered.

In step 1020, the time capsule is saved, for example, by a user selecting a save input. In an embodiment, the user may also be prompted to confirm submission of the time capsule, for example, via a pop-up overlay. The time capsule is stored (e.g., in database(s) 114) until the condition is satisfied.

In step 1025, process 534 blocks or waits until the condition is satisfied. The determination that the condition has been satisfied may comprise receiving a notification (e.g., via a screen of the graphical user interface), indicating that the condition has been satisfied, from one of the trustee(s) selected in step 1015. Alternatively, the initial decision that the condition has been satisfied may be received from any user. As another alternative, the application may automatically determine that the condition has been satisfied (e.g., if the condition is simply a time or the passage of a time period). In either case, if it is initially determined that the condition has been satisfied (i.e., “YES” in step 1025), process 538 proceeds to step 1030. Otherwise, if the condition has not yet been satisfied (i.e., “NO” in step 1025), process 538 continues to wait for satisfaction of the condition.

In step 1030, at least one trustee must confirm that the condition has been satisfied. For example, upon the determination in step 1025 that the condition has been satisfied, a notification may be sent to one or more of the trustees selected in step 1015 (e.g., all of the trustees except for the one trustee who notified the application that the condition was satisfied in step 1025). The notification may appear as an entry in each recipient trustee's notifications list in his or her respective notification screen, with a “confirm” or “deny” input similar to the “accept” or “decline” input used for contact requests.

In an embodiment in which a plurality of trustees are selected in step 1015, a first trustee may be required to initially notify the application in step 1025 that the condition has been satisfied, and a second, different trustee may be required to verify in step 1030 that the condition has been satisfied. Alternatively, in an embodiment in which it is possible for a user to select only one trustee in step 1015, any user may be allowed to notify the application in step 1025 that the condition has been satisfied, and at least one trustee may be required to verify in step 1030 that the condition has been satisfied. In additional or alternative embodiments, a certain percentage (e.g., a majority) or all of the trustees may be required in step 1030 to confirm satisfaction of the condition.

If the trustee(s) do not confirm that the condition is satisfied (i.e., “NO” in step 1030)—for example, at least one or a majority of trustees deny that the condition has been satisfied or fail to confirm that the condition has been satisfied—process 538 returns to waiting in step 1025. Otherwise, if the trustee(s) confirm that the condition has been satisfied (i.e., “YES” in step 1030), process 538 proceeds to step 1035.

In step 1035, once the condition has been satisfied and confirmed, the time capsule is delivered to the recipient contact(s) identified in step 1005. For example, a notification of the time capsule may appear as an entry in each recipient contact(s)' notifications list in his or her respective notification screen (e.g., with inputs for opening, accepting, or declining the time capsule). Automatically or upon acceptance of the time capsule by a recipient contact, the content items from the time capsule may be added to the recipient contact's legacy or otherwise made available for viewing by the recipient contact.

Process 538 enables a user to essentially transfer his or her memories (e.g., represented as one or more stories) to another user. In the event that the condition is the user's death, step 1035 is analogous to the delivery of an inheritance to the recipient contact(s).

The time capsule may also be used for future publication of a story (e.g., after ten years). In this case, the time capsule may consist of a single story and there may be no need for trustees (e.g., steps 1015 and 1030 may be omitted), since satisfaction of the condition can be easily verified by the application by simply comparing the current time to the time at which the time capsule is to be published. In addition, the recipient contact(s) may be determined by a privacy setting associated with the story to be published. The story may be published at the future date and at the associated privacy setting, and, until the date of publication, may not be available to any user other than the user who created it. In such an embodiment, each story may be associated with an isTimeCapsule property and storyDeliveryDate. The isTimeCapsule property is a Boolean value defining whether or not the story is subject to time capsule restrictions, and the storyDeliveryDate defines the publication date. The application may periodically (e.g., every day at midnight) query stories to retrieve all stories with a storyDeliveryDate matching the current date and having an isTimeCapsule property set to true. All retrieved stories can then be delivered, in step 1035, to the respective contact(s), specified in step 1005, for each story.

In an embodiment, the user who created the time capsule may be permitted to lock its contents (e.g., by setting an isEditable property associated with the time capsule to false), so that the time capsule can no longer be updated, even before the date of publication or delivery. This ensures that ownership of the time capsule is passed to the trustee(s) with no ability to alter the content and publication/delivery date of the time capsule. Regardless of whether or not the isEditable property is used or set, it should be understood that the content item(s) within the time capsule cannot be viewed by any users, other than perhaps the user who created the time capsule, until the time capsule has been delivered in step 1035.

2.7. Highlights

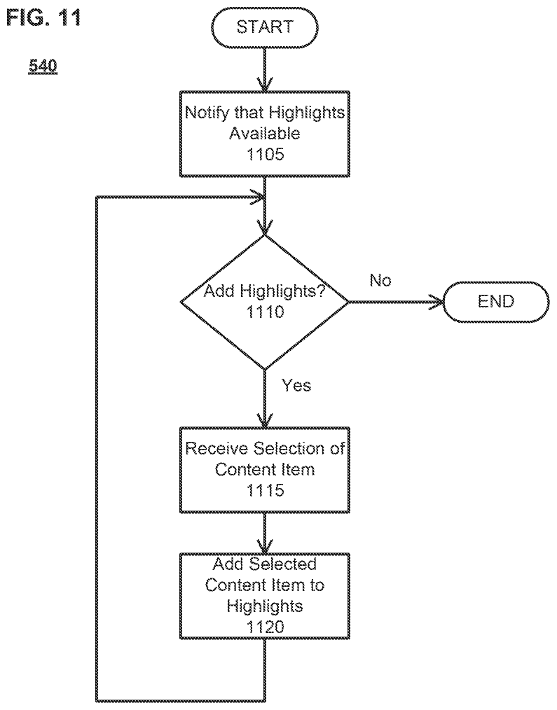

FIG. 11 illustrates highlights process 540, according to an embodiment. Highlights process 540 may be used by users to view highlights of their memories.

In step 1105, the application notifies a user that highlights are available, for example, via an entry in the user's notifications list of the user's notification screen. The application may automatically generate highlights and notify the user of the availability of the highlights after each of a plurality of time intervals (e.g., at the end of each year). Highlights may be automatically generated using one or more criteria to select a subset of the content items (e.g., stories) created by the user over the course of the time interval (e.g., most frequently read stories, most “liked” stories, most commented upon stories, stories associated with particular topics, etc.).

In step 1110 the user is provided with the option of viewing the highlights and adding content items to the highlights. If the user chooses to add a new highlight (i.e., “YES” in step 1110), process 540 proceeds to step 1115. Otherwise, if the user does not wish to add highlights or has completed adding all of the desired highlights (i.e., “NO” in step 1110), process 540 ends.

In step 1115, a selection of a new content item to add to the highlights is received. For example, the user may select a content item to add to the highlights from his or her legacy, via a screen similar or identical to the main legacy screen. In step 1120, the selected content item is added to the highlights, and process 540 returns to step 1110.

In an embodiment, once the highlights have been completed, the user may view the highlights and/or publish the highlights (e.g., via a publish input 439) as a story (e.g., to be shared with one or more of the user's contacts in accordance with a selected privacy setting).

2.8. Event Collector

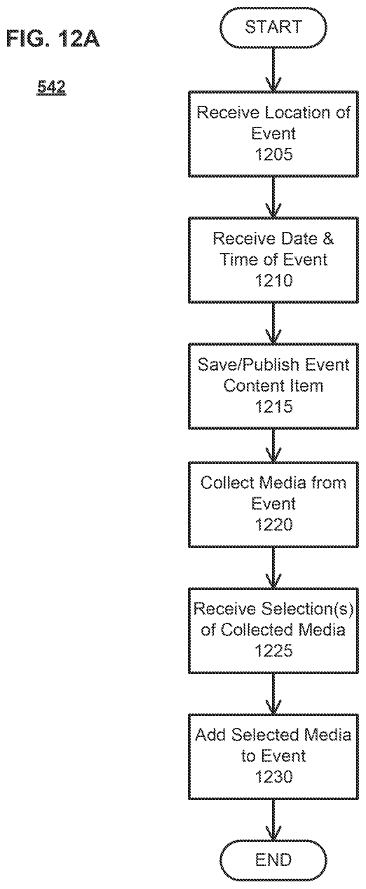

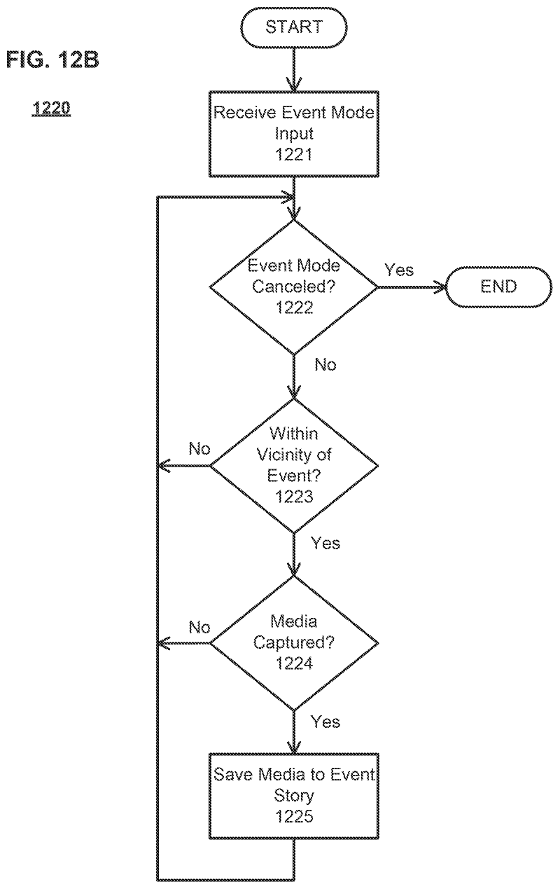

FIG. 12A illustrates event-collector process 542, according to an embodiment. Events-collector process 542 may be used to facilitate the collection of media for a scheduled event.

In steps 1205 and 1210, an event is defined. Specifically, in step 1205, the location of the event is received, and, in step 1210, the date(s) and time(s) of the event are received. Both the location and date and time of the event may be received via inputs of one or more screens in the graphical user interface provided by the application. The location may comprise Global Positioning System (GPS) coordinates for the event and/or an address of the event. The date and time of the event may comprise a start date and/or time and an end date and/or time of the event. After the event has been defined, a content item may be created for the event. In an embodiment, the event may be defined as part of a user's account (e.g., as part of the user's legacy), or may be defined as part of a separate event account managed by one or more users.

In an embodiment, one or more contacts or groups of contacts may be invited to attend the event. For example, during creation of the event, the user may specify one or more individual contacts or may associate the event with a particular privacy setting. Depending on the selected privacy setting, the event may be made public (i.e., available to all users of the application, possibly including non-users), semi-public (e.g., available to a subset of all users of the application who satisfy certain specified criteria, such as residing in a particular geographic location within a vicinity of the event, having certain interests specified in their profiles, etc.), available to all the user's contacts, available to a subset of the user's contacts (e.g., all contacts having a specified relationship to the user, such as “friends,” “family,” “coworkers,” etc.), and/or the like.

In step 1215, a content item for the event is saved and/or published, for example, by a user selecting a “save” or “publish” input (e.g., publish input 439). In an embodiment, the user may also be prompted to confirm saving or publishing the event, for example, via a pop-up overlay. The content item for the event may be similar or identical to a story, comprising text (e.g., the date(s) and time(s) of the event, the location of the event, a description of the event, etc.) and one or more media.

In step 1220, media from the event is collected. The collected media may comprise official media, for example, uploaded by the user who created the event or a user, authorized by the user who created the event, to manage the event. In addition, the collected media may comprise unofficial media, for example, uploaded by other users who attended the event. Media may be uploaded using the screens illustrated in FIGS. 4T, 4U, and 4V or similar screens.

In an embodiment, media may be automatically collected in addition to or instead of being uploaded by users. For example, in an embodiment in which the event is associated with a set of users or a privacy setting that designates a set of users, an invite to the event may be sent to each user in the set of users. The notification may appear as an entry in each user's notifications list in his or her respective notification screen, with inputs for either accepting or declining the invitation (e.g., similar or identical to the friend request, illustrated in FIG. 4E). If a user accepts the invite to the event, that user may be associated with the event within a database of the application (e.g., database(s) 114). During the event (i.e., within the time range defined by the start date and time and the end date and time), the client application 132 of each user, associated with the event, may automatically upload media captured by the user to an event collector at server application 112 (e.g., in the background). The event collector may comprise databases of media (e.g., stored in database 114) that are each associated with a particular event. When new media is received for an event (e.g., over network(s) 120), the application (e.g., server application 112) may determine an event to which the new media belongs (e.g., by comparing a unique event identifier associated with the new media to previously stored event identifiers associated with the databases of media, and matching the unique event identifier to one of the previously stored event identifiers), and add the new media to the database of media associated with the determined event.

Before initiating the automatic upload process, the application may verify that the user is at the event location, for example, by comparing a current location of the user's user system 130 (e.g., determined from a GPS receiver of user system 130) to the event location received in step 1205. If the current location of user system 130 is within a predetermined vicinity (e.g., radius) of the event location, the application verifies that the user is attending the event. In addition, before initiating the automatic upload process, client application 132 may prompt the user to confirm that he or she grants permission for the application to automatically upload media captured during the event to the event collector. Alternatively, the graphical user interface of the application may prompt the user the confirm whether or not a particular medium should be uploaded to the event collector after each medium is captured, or enable the user to select the particular media, if any, to be uploaded to the event collector at any time during or after the event.

In step 1225, an authorized user, associated with the event (e.g., the user who created the event content item, a user associated with the event account, etc.), may select event media from the event collector via one or more screens in the graphical user interface provided by the application. The authorized user may select none, some, or all of the event media, collected for the event in step 1220. This allows the authorized user to prevent inappropriate (e.g., offensive) media from being incorporated into the event content item. In addition, one or more image-processing algorithms may be performed on the event media collected in step 1220 to flag inappropriate content to aid in the authorized user's selection process.

In step 1230, all of the event media selected by the authorized user in step 1225 may be incorporated into the event content item, such that it is visible in the content item in a similar or identical manner as illustrated with respect to a story.

It should be understood that, in an alternative embodiment, steps 1225 and 1230 could be omitted, so as to permit the incorporation of all collected event media into the event content item. However, in such an embodiment, image-processing algorithm(s) could still be performed on the event media to flag inappropriate content, such that flagged event media are not incorporated into the event content item until and unless they are approved by an authorized user. Alternatively, the application could rely on users to flag inappropriate media.

In an embodiment, the application may comprise an event mode, which implements one or more of the steps in event-collector process 542. For example, a user may perform an operation (e.g., select an event input on an icon bar or as one of the tabs of the graphical user interface, select an event mode in the application menu, etc.) to set the application (e.g., the user's client application 132) into event mode. Once in the event mode, the graphical user interface of the application may comprise, be dominated by, or be dedicated to an event-recording screen.

The event-recording screen may comprise one or more inputs by which the user may define event information for the event, such as a title, description, and/or the like. In an embodiment, the event may be structured as a story that is associated with an “event” topic. The “event” topic may be automatically selected as the topic for the event. In other words, the event may utilize the same data structure(s) as any other type of story, and be designated as an event simply by its association with the “event” topic.

While the user's application is in the event mode, the application may automatically determine when the user is at the event based on the location of the user's user system 130. Furthermore, while the user's application is in the event mode and the user is determined to be at the event, the application may automatically save any media—captured by user system 130, for as long as user system 130 remains within a predetermined radius (e.g., one mile) of the location defined for the event—to the event story. In addition to being saved to the event story, the media may also be saved to the user's camera roll.

FIG. 12B illustrates an example implementation of step 1220, according to an embodiment which utilizes the event mode. In step 1221, an input is received from the user to initiate the event mode. In response, the application (e.g., client application 132) starts the event mode. For as long as the event mode remains active, steps 1222-1225 are performed.

In step 1222, the process determines whether or not the event mode has been canceled. The event mode may be canceled, for example, by a user operation (e.g., selecting the same input that was used in step 1221 to initiate the event mode, or by selecting a different input). In an embodiment which utilizes the event-recording screen, the event mode may be canceled in response to an input on the event-recording screen, such as an input that closes the event or stops the recording. Alternatively or additionally, the application may automatically cancel the event mode after it has been determined that the user's user system 130 was within the vicinity (e.g., predetermined radius) of the location defined for the event, but has since moved outside the vicinity of the event location. In this case, the application may wait to cancel the event mode until the user has moved and remained outside the vicinity of the event location for at least a predetermined amount of time (e.g., five minutes), and/or may automatically restart the event mode if the user returns to the vicinity of the event location.

In an embodiment, during the event mode, the media, captured by a user system 130, may be accumulated in local at user system 130 (e.g., in local database 134). After the event mode has ended (e.g., been canceled in step 1222), the locally accumulated media may then be collectively uploaded to and stored at platform 110 (e.g., in database 114) via network(s) 120. Alternatively, during the event mode, the media, captured by a user system 130, may be uploaded to and stored at platform 110 as it is captured, instead of cumulatively after the event mode has ended.

In step 1223, the process determines whether or not the user is within a vicinity (e.g., predetermined radius) of the event. For example, the application may obtain the current location of the user's user system 130 from a GPS receiver of user system 130, and compare the current location to the location that has been defined for the event. If the current location of user system 130 is within a predetermined radius of the event location (i.e., “YES” in step 1223), the process proceeds to step 1224. Otherwise, if the current location of user system 130 is not within the predetermined radius of the event location (i.e., “NO” in step 1223), the process returns to step 1222.

In step 1224, the process determines whether or not one or more media (e.g., photograph, video, audio, etc.) have been captured. If any media has been captured (i.e., “YES” in step 1224), the process proceeds to step 1225. In step 1225, the media captured in step 1224 is saved to a story for the event (e.g., a story associated with the “event” topic). Otherwise, if no media has been captured (i.e., “NO” in step 1224), the process returns to step 1222 to wait for new media captured within the vicinity of the event during the event mode.

In an embodiment, even if the event story has already been published, new media added to the event story may remain unpublished until specifically published by a user authorized to do so for the event story (e.g., the user who created the event story). In such an embodiment, media that is added to the event story is not published as a permanent part of the event story until the user chooses to publish the newly added media. For example, each newly added medium may have a delete input associated with it. When the user selects the delete input for one or more media, the selected media are deleted from the event story and never published in association with the event story. In addition, each newly added medium may have a publish input associated with it. When the user selects the publish input for one or more media, the selected media are added to the previously published event story. Thus, advantageously, all of the event-related media are collected with the event story for easy review, editing, deletion, and publication by an authorized user.

In an embodiment, as media are edited and/or deleted within an event story, those media may also be automatically edited and/or removed, respectively, from the user's camera roll. In addition, once media are published with the event story, all of the published media may be deleted from the user's camera roll (e.g., in response to a user operation to a prompt to confirm the deletion from the user's camera roll). Advantageously, this feature keeps the user's camera roll clean and, if the camera roll is locally stored on the user's user system 130, frees up space on the user system 130.

In an embodiment, each medium collected in step 1220 may be associated with a location (e.g., GPS coordinates) and/or time (e.g., timestamp) of capture (e.g., in metadata added by client application 132 or another application). In addition, the event content item may comprise, provide a link to, or otherwise be associated with a virtual event map. The virtual event map may comprise a virtual map of the event location (e.g., retrieved from a third-party external system 140, such as Google Maps™), with each collected medium represented on the map (e.g., by a selectable icon) at its associated relative location (e.g., relative to the GPS coordinates of the event location represented in the map). Thus, a user, viewing the virtual event map, may select a representation of any of the collected media to view the selected medium (e.g., in a pop-up overlay), while comprehending the relative location at which the selected medium was captured within the event.

In addition, the virtual event map may be viewed at each of a plurality of times within the time range during which the event occurred. For example, the virtual event map could comprise a time slider, which allows a user to transition the virtual event map from the start time of the event to the end time of the event. As the virtual event map is transitioned between times, it may be updated to only include representations of media captured at those times (e.g., as determined from the times of capture in metadata associated with the media). Thus, a user, viewing the virtual event map, may also easily comprehend the relative time at which the media were captured.

In an embodiment, the application may provide contributors or sponsors access to the virtual event map in conjunction with analytics and/or algorithms. For example, the virtual event map may show a location, defined as the event site, and relative geo-located landmarks from the event (e.g., stage locations). The virtual event map may be a quadrant map, which allows the contributors or sponsors to see where they were located and/or where they would like to be located. In addition, the contributors or sponsors may be provided with a menu of media published from each location (e.g., from each landmark).

In an embodiment, further processing of the media and other information allows for a virtual reality experience. For example, media could be stitched together based on location (e.g., recorded in the metadata for the media) and time (e.g., recorded as a timestamp, representing the time at which the media was captured, in the metadata for the media). In other words, media from the same location or vicinity, which was captured at or around the same time, may be combined into a composite medium. The composite medium may be created by matching patterns within two or more media, captured at or near the same location at or near the same time, and using the patterns to determine their relative positions to each other and overlap or otherwise stitch the media together, at their relative positions, into the composite medium. This would allow users to experience what other users' saw, or are currently seeing, from an associated landmark (e.g., the front row of an event, fifty-yard line of a football game, backstage, from a small body camera on an athlete during a key play in a game, etc.).

2.9. Advice

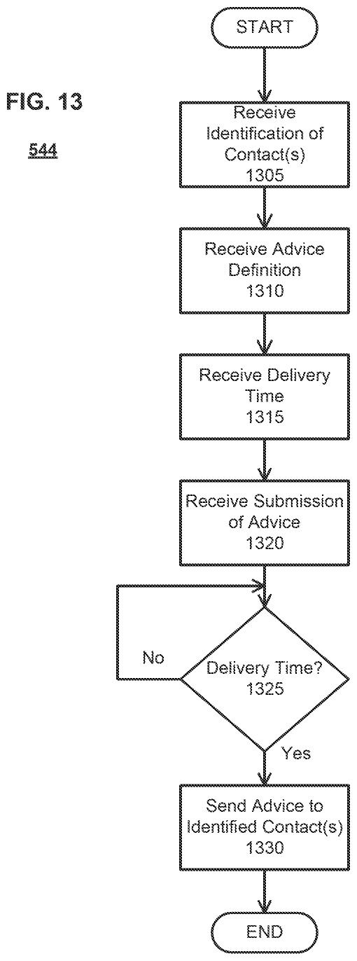

FIG. 13 illustrates advice process 544, according to an embodiment. Advice process 544 may be used by a user to provide advice to other users.

In step 1305, one or more contacts are identified as the recipient of advice. The contacts may be identified, for example, by receiving a selection of one or more contacts within a user's contacts list, such as the contacts list in the contacts screen illustrated in FIG. 4O, or search results.

In step 1310, the advice is defined. For example, a user may create the advice in a similar or identical manner as other content items (e.g., stories). Thus, the advice may comprise text and/or media (e.g., photographs, charts, etc.).

In step 1315, a delivery time is specified by the user. The delivery time may comprise a future day and/or time or the current time.

In step 1320, the advice is submitted, for example, by a user selecting a submission input. In an embodiment, the user may also be prompted to confirm submission of the advice, for example, via a pop-up overlay.

In step 1325, process 544 blocks or waits until the specified delivery time. At the delivery time (i.e., “YES” in step 1325), process 544 proceeds to step 1330. Otherwise, if the delivery time is still in the future (i.e., “NO” in step 1325), process 544 continues to wait until the delivery time. It should be understood that when the user selects the current time, as opposed to a future time, as the delivery time in step 315, step 1325 is essentially skipped or omitted.

In step 1330, the advice, selected or defined in step 1310, is sent to the contact(s), identified in step 1305, at the delivery time, specified in step 1315.

2.10. Curation

In an embodiment, curation process 546 provides for easy curation by a user of his or her content items, including managing the source, publication, and deletion of the user's own content items, the selection of contacts, topics, or retention of content items received from other users, and/or the like.

For example, the user may tag his or her content items (e.g., stories) with keywords or other metadata to improve the content items' position in search results, as well as to organize or categorize the user's content items. In an embodiment, content items may be tagged using common life milestones (also referred to herein as “topics”), such that the categorization of the content items, itself, can tell a story about the user's life (e.g., the importance of travel to the user). In addition, the use of common life milestones to categorize content items makes the content items easily retrievable and shareable. Essentially, the application can be used as a filing cabinet for the user's life, for example, with thousands of photographs grouped and organized into modular stories, each representing a memory of the user, that can be easily searched, shared, and passed on.

In an embodiment, the application employs a fast search algorithm to retrieve content items based on milestone/topic, keywords, and/or other metadata. Thus, content items can be easily and intuitively searched by user, milestone/topic, keyword, and/or the like.

In an embodiment, the application enables a user to limit review of his or her data feed (e.g., notifications list) to content items (e.g., content item 425) for particular contacts on particular milestones/topics. The data feed may be sorted according to date and/or category, so that the user can readily review new content items for particular milestones/topics from particular contacts. For example, as illustrated in FIGS. 4H and 4I, contacts who have new stories are identified in expandable contact entries 422 in the user's notifications list in the user's notification screen (e.g., in alphabetical order of contact's name). Each contact entry 422 can be expanded to show all of the new stories 425 posted by that contact, and, optionally, if a user desires, to show all stories 425 in that contact's legacy or all stories 425 with new comments. Thus, a user does not have to worry about missing a story from an important contact, as is the case with many conventional social media platforms, when the story ends up buried deep within the user's data feed due to more recent stories from other contacts, sponsored posts, and/or the like.

In an embodiment, an indication (e.g., a yellow dot next to the contact's avatar) may be provided for each contact entry 422 in the user's notifications list that contains an unread story, and/or for each unread story entry 425 within a contact entry 422. Once a story is interacted with (e.g., expanded, commented upon, “liked”, etc.), the indication for the unread story may be removed, and once all stories 425 from a particular contact have been interacted with, the indication for that contact's entry 422 may be removed. In addition, a story 425 or contact entry 422 can be deleted from the user's notifications list, for example, by interaction with a delete input (e.g., 424 or 426, respectively) associated with the story 425 or contact entry 422. In one (e.g., only when deleting a contact) or both cases, confirmation may be required (e.g., via prompting by a pop-up overlay).

In an embodiment, a user may block content items based on topic, generally or per contact. For example, each content item 425 is associated with a topic and may be associated with an input that, when selected, provides a selection box (e.g., as a pop-up overlay) which provides inputs for blocking the topic associated with the story. The inputs may provide an input for blocking content items associated with that topic and the particular contact who posted the associated story, and an input for blocking all content items associated with that topic, regardless of the contact who posts them. If blocked, future content items associated with the blocked general topic or blocked contact-specific topic will no longer appear in the user's notifications list. Once blocked, the input associated with a blocked story may be changed to indicate that the story is blocked, and the user may unblock the topic by again selecting the input (optionally after confirmation, for example, via a pop-up overlay).

In an embodiment, the use of stories as the primary—or, in some embodiments, only—type of content item brings the user's media to life. For example, where a user went, what the user did, how the user did it, and with whom the user did it gets collected into a modular content item (e.g., content item 425) representing a human memory that can be stored, retrieved, shared, and passed on (e.g., to the next generation) in a modular or atomic manner.

In an embodiment, advertisements may appear in association with an “advertisements” and/or “bucket list” topic. The application may utilize an algorithm to identify keywords in content items (e.g., stories) posted or consumed by a user, and serve advertisements, relevant to the identified keywords, to that user under the “advertisements” and/or “bucket list” topic. Posted advertisements in these topics may be deleted (e.g., in a similar or identical manner as other content items) or retained for future access by the user. When a retained advertisement expires, it may be automatically replaced with a new advertisement, if appropriate, or deleted.

2.11. Proxy Account

In an embodiment, proxy-account process 548 may provide for the creation of “proxy” accounts. A proxy account replicates some or all of a user's account. For example, the proxy account may comprise a copy of all or a subset of content items (e.g., stories) within a user's legacy, such as all content items associated with one or more particular topics/milestones.

In an embodiment, the application may provide a screen that permits a user to define a proxy account by, for example, selecting at least a subset of content items to be included in the proxy account (e.g., by selecting individual content items 425 or by selecting a certain topic so as to include all content items associated with that topic).

It should be understood that the proxy account is separate and distinct from the originating user's own account. However, in an embodiment, the proxy account is not actually generated until a time chosen by the user. For example, a user may define the proxy account at a first time, and then, at a second time, choose to actually create the proxy account. Of course, it should be understood that the first time could be the same as or earlier than the second time.

Upon creation, the proxy account is generated to include copies of all content item(s) (e.g., all content items associated with topic(s) selected by the user when defining the proxy account) specified for the proxy account. As such, the proxy account becomes a separate, transferable account from the originating user's own account. Thus, if and when desired, the originating user can transfer the proxy account to another user.

For example, a parent may create a proxy account to pass on to his or her child when the child turns eighteen or after the parent's death. Thus, in an embodiment, the proxy account could form the contents of a time capsule, as discussed elsewhere herein with respect to FIG. 10 and time-capsule process 538.

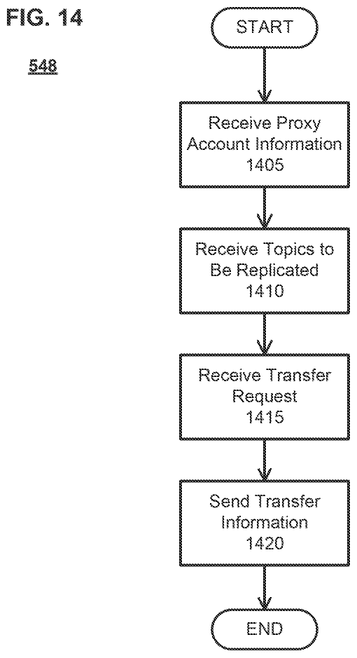

FIG. 14 illustrates proxy-account process 548, according to an embodiment. Proxy-account process 548 may be used by a user to transfer or otherwise send a portion of his or her account (e.g., content items) to another user. Process 548 may be initiated by a user selecting an input, in one or more screens of the application (e.g., settings screen), for setting up a new proxy account.

In step 1405, information for the proxy account is received, for example, via one or more screens of the application. The information may comprise a name of the account or proxy holder (i.e., transferee), an email address of the proxy holder, account information, and/or the like.

In step 1410, the topics to be replicated in the proxy account are specified, for example, via one or more screens of the application. For example, the user may select one or more (including all) topics (e.g., representing life milestones), from a list of available topics, to be replicated in the proxy account. Once defined (e.g., by input of the information in step 1405 and specification of topic(s) in step 1410), a proxy account may be published in the user's legacy. Alternatively or additionally, the user may select one or more of his or her content items, individually or in groups, to be replicated in the proxy account.

At any time following definition of the proxy account in steps 1405 and 1410, in step 1415, a user may request transfer of the proxy account via one or more screens of the application. For example, the user may select the proxy account (e.g., from the user's legacy screen) and select a “transfer” input. In an embodiment, the user may also be prompted to confirm transfer of the proxy account, for example, via a pop-up overlay.

Once transfer has been selected and/or confirmed in step 1415, in step 1420, transfer information for the proxy account is sent to the proxy holder. For example, the application may send an email to the email address of the proxy holder specified in step 1405. The email may comprise a link and/or temporary credentials (e.g., temporary password) to gain access to the proxy account. Once the proxy holder logs in for the first time (e.g., using his or her email address as a username and the temporary password as the password), he or she may be prompted to change his or her password, complete a profile, and/or the like, similarly to create-account process 510.

In an embodiment, a proxy account may be implemented using a proxy_user table (e.g., in database(s) 114), which contains a user_id and account_owner_id for each proxy account. The user_id is a foreign key identifying the current user (e.g., in a user table in database(s) 114) associated with the proxy account, and the account_owner_id identifies the user (e.g., in the user table) who owns the proxy account. A single user, as defined by account_owner_id, can have a one-to-many relationship with proxy accounts represented in the proxy_user table.

In addition, the user table may contain an isProxy property and account_owner_id for each represented user. The isProxy property is a Boolean value that defines if a legacy of the user is a proxy account, and, if the isProxy property is true, the account_owner_id identifies the account owner.

In an embodiment, all updates to a user's legacy, prior to transfer of the proxy account, are mirrored in the legacy of any related proxy account. For example, if the user creates a proxy account for the “travel” topic and then subsequently creates a new content item associated with the “travel” topic before transfer of the proxy account, that content item will be automatically added to the proxy account.

In an embodiment, once ownership of the proxy account is transferred to the proxy holder, all content items mirrored in the proxy account will exist in both the legacy of the transferor's account and the legacy of the proxy account. However, after the transfer, any updates to content items in the legacy of the transferor's account will no longer be reflected in the legacy of the proxy account, and any updates to content items in the legacy of the proxy account will not be reflected in the legacy of the transferor's account. Thus, each account becomes separate and distinct.

2.12. Dictation

In an embodiment, dictation process 550 enables a user to dictate the textual portion of a story. While a user may be prompted to input text via a hard or soft keyboard (e.g., via pre-populated verbiage of “Description” or “Comment” in text input(s) for the story), the application may also allow for dictation of text input via a microphone. Specifically, upon selection of a microphone input, associated with a text input (e.g., text input 425) in a screen for creating a story, client application 132 may initiate recording of an audio file (e.g., a Wave Audio File Format (WAV) file). During recordation of the audio file, recording controls (e.g., start, stop, pause, delete, etc.) may appear in the story creation region (e.g., input 434).

Once recorded to the user's satisfaction, the audio file may be transcribed (e.g., via well-known speech-to-text functions, for example, provided by the operating system or other application of user system 130) into text, which is then inserted into the text input (e.g., text input 435) for the story. The user may edit the text as needed, prior to publishing the story.

In addition to inserting the transcribed text into the story, the audio file may be attached (e.g., as one of the media) to the story. Thus, once published, viewers of the story could select the audio file for playback (e.g., via a speaker icon associated with the story 425) to hear the story in the voice of the user who created the story. During playback, playback controls (e.g., stop, start, pause, rewind, fast forward, etc.) may appear within the story region 425.

2.13. Family Tree

In an embodiment, family-tree process 552 generates a family tree comprising a hierarchical organization of a user's familial relationships to other users.

In an embodiment, a familial relationship between two users can be added to the users' social networks when establishing a contact. For example, when a user requests to establish a contact with another user (e.g., via an “add contact” input), inputs (e.g., drop-down menu, pop-up overlay, etc.) may be provided for the user to specify a relationship (e.g., family, friend, coworker, schoolmate, etc.) to the prospective contact. If the user selects the “family” relationship, more inputs may be provided for the user to specify the type of familial relationship (e.g., parent, father, mother, sibling sister, brother, niece, nephew, uncle, aunt, cousin, child, son, daughter, etc.).

Once the desired familial relationship is selected, the request to establish contact is provided to the prospective contact in the same manner as described elsewhere herein (e.g., provided as a contact entry 422 with “accept” and “decline” inputs in the prospective contact's notifications list). However, the request may also specify the desired familial relationship. If the prospective contact accepts the request, the familial relationship between the requesting user and new contact is added to both users' social networks (e.g., by being recorded in database(s) 114).

In an embodiment, the application may provide a screen of the graphical user interface that comprises a visual representation of the user's family tree. For example, a tab may be added for the family tree screen to the plurality of tabs 410, 412, and 414 that include links to the notification screen, contacts screen, and legacy screen, respectively.

The application builds the family tree using the familial relationships established within the user's social network. In an embodiment, the application may infer familial relationships, if appropriate, in the absence of an explicit familial relationship within the user's social network. For example, if the current user has an established “father” relationship with a first user, the first user has an established “brother” relationship with a second user, and the second user has an established “son” relationship with a third user, the application may infer a “cousin” relationship between the current user and the third user despite no established contact between the current user and the third user.

The visual representation of the user's family tree may be displayed as a graph with nodes representing users and edges representing relationships between the users. It should be understood that a first user who is a child of a second user may be represented, in the family tree, as a child node to a parent node representing the second user, with the edge between the child and parent nodes representing a “son,” “daughter,” or generic “child” relationship. Each node may comprise the avatar and/or name of the represented user, and the edges may comprise simple lines and/or a textual description of the relationship between the connected nodes.

In an embodiment, inferred familial relationships may be distinguished from established familial relationships, for example, by using a different color for the edge (e.g., a lighter color) and/or node (e.g., a different background color, such as gray, for the avatar of the user represented by the node, a grayed out name for the user, etc.). Each node representing an inferred relative may also be associated with inputs for requesting a connection to the user represented by that node (e.g., with the inferred familial relationship pre-specified in the request by default).

In an embodiment, users with established relationships and who have posted content items that have not yet been read by the current user may be represented by a node with an indication (e.g., yellow dot, different background color, distinguished border, etc.) that the user has posted unread content items. Selecting a node, representing a user who is a contact of the current user, may direct the current user to that contact's legacy screen.

In an embodiment, the family tree, generated and maintained by the application for each user, is used for resolving contact requests for a user, even after that user is no longer alive or is incapable of accepting contact requests (e.g., due to incapacitation). Specifically, contact requests from family members or a subset of family members (e.g., as determined by the application from the family tree) may be automatically approved if not declined within a predetermined period of time (e.g., two weeks) since the request was received. Thus, if a user dies or becomes otherwise incapacitated, such that he or she is no longer to manage his or her account, including accepting new requests to establish a contact, new contact requests from family members or a subset of family members will continue to be automatically approved. Thus, family members may continue to be provided with access to the user's legacy, even after that user has passed away or become incapacitated.

This is in contrast to conventional systems, which generally require account credentials to be passed on to a family member (e.g., via email, will, etc.) after a user has died or become incapacitated. In such a system, the family member, who is entrusted with the credentials, may continue operating the account, including editing (e.g., adding or deleting) the user's legacy. However, such editing may lead to the undesirable outcome that the user's original content items (e.g., stories representing modular memories, including descriptions, photographs, videos, etc.) are lost for future generations. In addition, family squabbles may arise as to how the account should be managed.

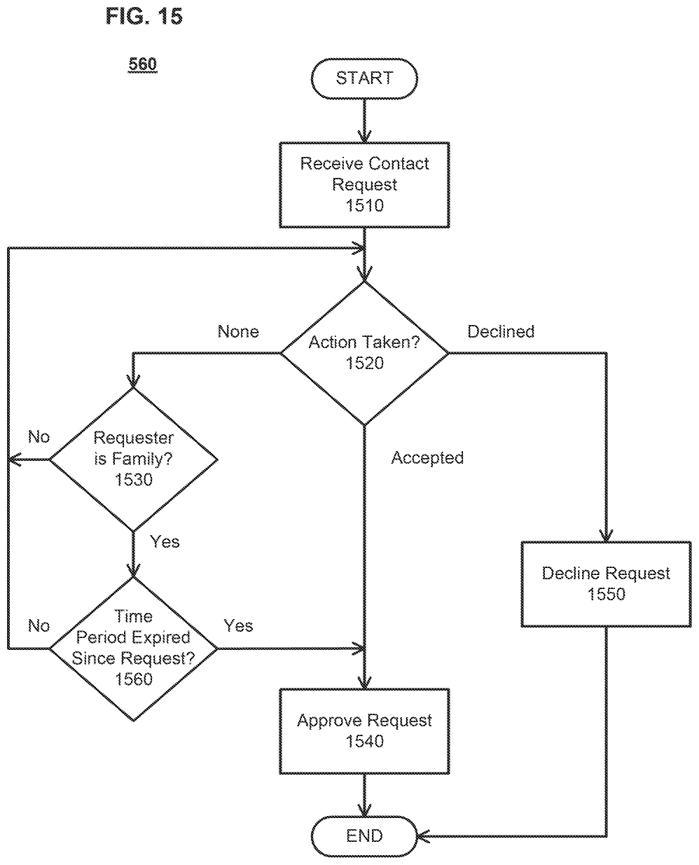

FIG. 15 illustrates an automated-approvals process 560, according to an embodiment. Automated-approvals process 560 may be used to preserve a user's legacy after the user's death or incapacitation.

As discussed above, a family tree is maintained for a user. This may be a continual process that occurs in the background, for example, as family-tree process 552. Specifically, the family tree for a user will develop as that user's social network evolves to include explicit familial connections with other users. In addition, family-tree process 552 may infer further familial connections based on these explicit familial connections (e.g., inferring a cousin relationship between a first user and a second user based on explicit parent relationship between the first user and a third user, an explicit parent relationship between the second user and a fourth user, and an explicit sibling relationship between the third user and the fourth user).

In step 1510, a contact request is received. Specifically, as discussed elsewhere herein a first user may submit a request to establish a direct contact with a second user. The graphical user interface may then present the request in the second user's notifications list as a contact entry 422 (e.g., with “accept” and “decline” inputs, as illustrated in FIG. 4E).

In step 1520, the process determines whether or not an action has been taken. Normally, the second user, with whom contact is being requested, will either accept the request (i.e., “Accepted” in step 1520), in which case the process proceeds to step 1540 such that the request is approved, or decline the request (i.e., “Declined” in step 1520), in which case the process proceeds to step 1550 such that the request is declined. In an embodiment, the second user could also request more information, as illustrated in step 920 in contacts process 536 in FIG. 9. However, in the event that the second user has died or become incapacitated, the second user will be unable to take the explicit action of accepting or declining the request.

Thus, in step 1530, the process determines whether or not the requesting first user is family to the second user, based on the family tree associated with one or both of the first user and the second user. Family may be defined as a certain degree of familial separation. For example, one degree of familial separation would include direct relatives, such as a parent, child, spouse, or sibling. Two degrees of familial separation may include grandparents, grandchildren, parent-in-laws, sibling-in-laws, and/or any other familial relationship with one intervening person. Three degrees of familial separation would include great-grandparents, cousins and/or any other familial relationship with two intervening people. More generally, N degrees of familial separation would include any familial relationship with N−1 intervening people. The application and/or the second user may specify what degree (i.e., N) of familial separation should count as family for the determination in step 1530. If the requesting first user is determined to be family (i.e., “Yes” in step 1530), the process proceeds to step 1560. Otherwise, if the requesting first user is not determined to be family (i.e., “No” in step 1530), the process returns to step 1520.

In step 1560, the process determines whether or not a predetermined time period has expired since the request was received in step 1510. The predetermined time period may be any suitable length of time, such as one week, two weeks, three weeks, one month, and/or the like. In general, the length of time should be set so as to provide the second user with a normal amount of time to either approve or decline the request. If the predetermined time period has expired since the request was received in step 1510 (i.e., “Yes” in step 1560), the process proceeds to step 1540. Otherwise, if the predetermined time period has not expired since the request was received in step 1510 (i.e., “No” in step 1560), the process returns to step 1520.

In step 1540, the request is approved. Specifically, a new connection is added in both the first user's social network and the second user's social network to provide a direct connection between the first user and the second user. In addition, in the event that there is a previously inferred familial relationship between the first user and the second user, an explicit familial connection, representing that familial relationship, is added to both the first user's family tree and the second user's family tree.

In contrast, in step 1550, the request is declined, such that no direct connection between the first user and the second user is added to either user's social network. However, it should be understood that if a familial connection exists between the first user and the second user, that familial connection may remain in both the first user's and the second user's family trees, despite the declination of the first user's request for a direct connection.

According to automated-approvals process 560, contact requests from family members (e.g., with N degrees of familial separation) may be automatically approved after the expiration of a predetermined time period. While this may occur while the user is still actively managing his or her account, the primary benefit is that contact requests from family members may be automatically approved even after the user has stopped actively managing his or her account, for example, due to death or incapacitation. Accordingly, even after a user has died or lost their ability to add new stories to his or her legacy, family members may still request and obtain access to the deceased or incapacitated user's legacy, and this legacy will remain preserved indefinitely in the state at which it existed at the time of the user's death or incapacitation. It should be understood that this continuing ability of family members to view and interact with the user's legacy (e.g., post comments, etc.) is assumed to reflect the user's wishes. Otherwise, the user could alternatively transfer his or her legacy or a portion or portions of his or her legacy using a time capsule (e.g., using time-capsule process 538 in FIG. 10) or a proxy account (e.g., using proxy-account process 548 in FIG. 14).

In an embodiment, if the second user has previously declined a request for a direct connection from the requesting first user (e.g., via steps 1520 and 1550), who is a family member, the application may automatically decline the request after the time period has expired (i.e., “Yes” in step 1560), instead of automatically approving the request. Since the second user was previously given the opportunity to approve the request, and chose instead to decline it, it may be assumed that the second user does not wish to provide the requesting first user with access to his or her legacy even after his or her death or incapacitation.

2.14. Profile

In an embodiment, profile process 554 enables editing of a user's profile, as illustrated, for example, in FIG. 4S.

2.15. Highlight Reel

In an embodiment, highlight-reel process 556 generates a highlight reel of a user's legacy. For example, the highlight reel may comprise a subset of important content items (e.g., most view content items, most commented upon content items, most “liked” content items, content items associated with certain topics, etc.) in the user's legacy.

2.16. Topics

As discussed elsewhere herein, content items may be associated with a topic or milestone. In an embodiment, topics process 558 enables a user to select multiple topics and/or specify relationships between topics. In addition, content items (e.g., stories) may be associated with multiple topics, for example, via user selection of multiple topics when creating the content item (e.g., using the screen illustrated in FIG. 4V). For instance, a user may select a primary topic, a secondary topic, a tertiary topic, and so on. As an example, a user could select the “holiday” topic and the “travel” topic to list stories associated with both the “holiday” and “travel” topics (e.g., a story for Christmas in Sweden, which combines holiday with travel, respectively).

2.17. Referral Markers

In an embodiment, a user may add one or more referral markers to a content item, such as a story. Specifically, a user may “tag” one or more character strings (e.g., one or more words, one or more phrases, etc.) in a story to link those character strings to another resource. This resource may be an external site, such as an online marketplace for purchasing products or services.

As an example, a user may create a story involving a particular item. The user may tag a reference to that item, while creating or editing the story, using one or more of inputs 434 on the legacy screen, and specify the resource to be associated with the tagged reference. In response, the application may automatically convert the reference into a link (e.g., hyperlink) to the specified resource. For example, a user creating a story about his experience piloting a drone may tag the word “drone” or the model or brand name of the drone, within the story, and specify a Uniform Resource Locator (URL) for a webpage at an online store (e.g., Amazon™, eBay™, etc.) from which another user can purchase the drone described in the story.

It should be understood that any items and resources can be tagged in this manner. For example, references to commercial products or services in the story may be tagged to online resources for purchasing the products or services. As another example, words or phrases in a story may tagged to other content items (e.g., another story) or knowledge bases (e.g., a Wikipedia™ entry for the tagged word or phrase, an online dictionary or encyclopedia entry for the tagged word or phrase, a journal or news article related to the tagged word or phrase, etc.). The graphical user interface of the application may visually distinguish tagged character strings from untagged character strings, for example, by highlighting tagged character strings (e.g., using a different colored and/or bolded font, a different colored background, underlining, italics, and/or any other different style), adding a dot (e.g., gold dot) next to each tagged character string, and/or the like.

In this manner, a reader of a user's tagged story can select tagged character string(s) to be instantly directed to relevant, associated resource(s). Using the drone example above, a reader may select the drone reference to be directed by the reader's browser to a webpage for an online store, at which the reader can purchase the same model of drone that was described in the story. Thus, as users become de facto experts in certain topics, they may leverage that reputation to market products or services via tags within their stories. In exchange, the users and/or operators of platform 110 may be paid a commission (e.g., fixed fee per click or lead, percentage of sales, etc.) by the sellers of the products or services.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method comprising, by a client application executed by at least one hardware processor of a mobile device:
switching from a normal mode to an event mode for a predefined event that is associated with an event time and an event location; and,
during the event mode,
comparing a location of the mobile device to the event location, and,
while the location of the mobile device is within a predetermined distance from the event location, automatically uploading media captured by the mobile device to a remote platform over at least one wireless network in a background of the mobile device.

2. The method of claim 1, further comprising, by the client application, before switching from the normal mode to the event mode, prompting a user to grant permission for the client application to automatically upload media.

3. The method of claim 1, wherein the event location comprises Global Positioning System (GPS) coordinates, and wherein the predetermined distance comprises a radius from the GPS coordinates.

4. The method of claim 1, further comprising, by a server application executed by at least one hardware processor of a remote platform:
generating a content item representing the predefined event; and,
during the predefined event,
receiving a plurality of media, automatically uploaded by a plurality of the client application executing on a plurality of mobile devices, and
automatically adding the plurality of media to the content item.

5. The method of claim 4, further comprising, by the server application, after generating the content item and before the event time, sending invitations to the predefined event to a plurality of users of a social networking site.

6. The method of claim 5, further comprising:
by the server application, after sending the invitations, receiving one or more acceptances from the plurality of users of the social networking site; and,
by the client application executing on a mobile device of each of the plurality of users from which one of the one or more acceptances was received, automatically switching from the normal mode to the event mode at a start of the event time.

7. The method of claim 4, further comprising, by the server application:
receiving a plurality of other media manually uploaded in association with the predefined event; and
adding the plurality of other media to the content item.

8. The method of claim 4, further comprising, by the server application, prior to adding the plurality of media to the content item, performing one or more image-processing algorithms on the plurality of media to flag inappropriate content.

9. The method of claim 4, further comprising, by the server application, publishing the content item such that the content item is accessible to a plurality of users of a social networking site.

10. The method of claim 9, further comprising, by the client application executing on each of the plurality of mobile devices, after the content item has been published, automatically deleting the uploaded media from local memory of the mobile device.

11. The method of claim 4, further comprising, by the server application, generating a graphical user interface that comprises a virtual map representing the event location, wherein the virtual map comprises, for each of one or more of the plurality of media, a representation of that media at a location at which that media was captured.

12. The method of claim 11, wherein the graphical user interface comprises a time slider, and wherein the method further comprises, by the server application, in response to movement of the time slider by a user, transitioning from a first time to a second time by removing representations of the plurality of media that were captured at the first time from the virtual map and adding representations of the plurality of media that were captured at the second time to the virtual map.

13. The method of claim 1, further comprising, by the client application, receiving a first user operation, wherein the switch from the normal mode to the event mode is performed in response to the first user operation.

14. The method of claim 13, further comprising, by the client application:
receiving a second user operation; and,
in response to the second user operation, switching from the event mode to the normal mode.

15. The method of claim 1, further comprising, by the client application:
during the event mode, determining whether or not the location of the mobile device has been outside the predetermined distance from the event location for a predetermined amount of time; and,
when the location of the mobile device has been outside the predetermined distance from the event location for the predetermined amount of time, automatically switching from the event mode to the normal mode.

16. The method of claim 15, further comprising, by the client application, when the location of the mobile device returns to within the predetermined distance from the event location after being outside the predetermined distance from the event location for the predetermined amount of time, automatically switching from the normal mode to the event mode.

17. The method of claim 1, further comprising, by the client application, during the event mode, displaying an event-recording screen on a display of the mobile device.

18. The method of claim 17, wherein the event-recording screen comprises one or more inputs for inputting event information.

19. A device comprising:
at least one hardware processor; and
one or more software modules that are configured to, when executed by the at least one hardware processor,
switch from a normal mode to an event mode for a predefined event that is associated with an event time and an event location, and,
during the event mode,
compare a location of the device to the event location, and,
while the location of the device is within a predetermined distance from the event location, automatically upload media captured by the device to a remote platform over at least one wireless network in a background of the device.

20. A non-transitory computer-readable medium having instructions stored therein, wherein the instructions, when executed by a processor, cause the processor to:
switch from a normal mode to an event mode for a predefined event that is associated with an event time and an event location; and,
during the event mode,
compare a location of a device, comprising the processor, to the event location, and,
while the location of the device is within a predetermined distance from the event location, automatically upload media captured by the device to a remote platform over at least one wireless network in a background of the device.
